(19) United States
(12) Patent Application Publication
(10) Pub. No.: US 2014/0156319 A1
(43) Pub. Date: Jun. 5, 2014

(54) WIRELESS COMMUNICATION SYSTEMS AND PROCESSES FOR HOSPITALITY SERVICES

(71) Applicant: Khaled Deeb, Miramar, FL (US)

(72) Inventor: Khaled Deeb, Miramar, FL (US)

(21) Appl. No.: 13/705,641

(22) Filed: Dec. 5, 2012

(51) Int. Cl. G06Q 50/12; G06Q 30/00

(52) U.S. Cl. CPC G06Q 50/12; G06Q 30/016
USPC 705/5; 705/304; 705/347

(57) ABSTRACT

The objective of this invention is to create real-time and time-shifted wireless messaging system that handles devices pairing and notifications between two or multi-line parties (e.g., waiters and customers). The invention facilitates prompt and wireless communication channels between customers and restaurant staff, increases customer satisfaction and improves customer request fulfillment (i.e., responsiveness). The invention also promotes a professional social network and a recruitment system for hospitality servers where they may review their ratings and promote their services. This social medium will also help food servicing stores and hospitality companies o locate highly qualified servers, assess Quality of Service (QOS) and benchmark with other services directly through system analytics and user interactions and feedback.

### CROSS-REFERENCE TO RELATED APPLICATIONS

This application claims the benefit of priority to U.S. Provisional Application Service entitled “ A Mobile and Electronic Application for Improving and automating the Quality and Communication of Hospitality Services,” filed on 15 of Oct. 2012, which is incorporated by reference herein in its entirety for all purposes.

### BACKGROUND OF THE APPLICATION

This invention relates generally to real-time messaging and time-shifted communication systems which are generally absent in business environments where interaction between customers and staff is critical for Quality of Service (QoS) and customer satisfaction. It has been found that often time it s difficult for customers to get prompt feedback and gain the attention of hospitality members. Often this is the case when employees are preoccupied or distracted. The problems noted above are solved in accordance with the present invention which provides a communication system to coordinate the interaction among customers and business members, such as customers and waiters respectively.

1. Description of the Prior Art

This invention relates to communication methods and processes that deal with dining experiences and restaurants services, including a variety of flow control schemes. Quality of Service (QoS), in addition to processes that deal with business operations, order placement and variable aspects of personal reviews.

The collection of processes and applications available to consumers today are limited mainly focusing on reviews of the dining experience, view of a particular restaurant's menu items, review special offerings, placing orders, and receiving discounts. Despite how efficient these processes and systems may be in their specific functions, they provide little integration and real-time or effective communication between patrons and staff. Another big limitation is that none of the solutions available to consumers today provide a means to directly communicate using two-way real-time messaging between consumers and the staff.

For example, at the core of the problems consumers experience while dining out, the major complaint is their limited ability to communicate with, or ability to communicate to, their server while the restaurant is busy. Wait staff typically serve more than one table at a time, and the amount of personal attention spent with each table/consumer is adversely impacted. This not only results in negative feedback and unhappy customers, but also makes the experience less enjoyable for consumers. The limited time spent with consumers causes problems when there are things that are incorrect with an order, or something minor is needed, such as a refill of a beverage, or to add a side, and there is no way to get the attention of the staff promptly.

In addition, a lot of dining places use a separate type of paging system for table reservations and guest seating, that places unnecessary and extremely stringent locational restrictions upon guests that cause consumers adverse displeasure right from the start of their dining experience. For instance, one of the most frustrating things about the dining experience is the amount of time that needs to be spent waiting for a table for seating. Most restaurants use some variation of a paging system that employs a hardware unit that sends alert messages when the table is available. While the current system works, it is not efficient or without flaws. The major flaw is that the consumer needs to physically wait right there in the vicinity. In situations where consumers end up having to wait for a table with a paging unit in hand, there is usually a large amount of people there waiting as well, leading to few, if any, seats available to sit in and wait in comfort, a loud and boisterous environment to wait in, and a long time to wait for the table.

An alternative solution would be to call or page customers on their mobile phones via SMS text message. However, this may present a privacy concern on the end of the customers and may deter some from releasing their phones to strangers.

Having the ability to review and rate an experience or a meal is a valuable tool to consumers and an asset to restaurant owners alike. Everything from the food, service, speed, cleanliness, and ambiance is categorically ratable today and greatly influences how consumers spend their money. The problem is that the applications available today that review/rate restaurants do just that, review/rate restaurants; nothing more, nothing less.

Near Field Communication [NFC] is a set of standards for wireless data transmission between mobile computing devices based on Radio-Frequency Identification [RFID]. This technology requires that two mobile devices contain the capability to perform NFC, usually reserved within an embedded NFC computing chip coded within the operating system for application use, to facilitate wireless data transmission.

BUMP technology uses NFC to transfer data between mobile device. However, the two devices must be in “physical contact”, and thus they need to get bumped together. The actual bumping of the two mobile devices ensures that the data will properly be transferred from, and delivered to, the correct sender and receiver. The application software transfers that data first to one of BUMP technologies servers, and then from their server to the other mobile device that has been selected to receive the data transfer.

2. Field of the Invention

The present invention addresses [05] and relates to a device pairing, information exchange, methods and programs which enable establishment of real-time and time shifted communications between two and plural entities facilitating the exchange of messages between customers and restaurant members. This communication system also defines a set of messages captured and stored on database servers for later reference and analytics.

To address the issue presented in [06], this invention infuses GPS functionality with a specially designed paging and seating platform that will eliminate the need for consumers to surrender their phone numbers or to physically wait for a seating assignment after they have checked in for their on-site reservation. This model may be most suitable for restaurants and/or dining places that are limited to on-site reservation. When reservation is near seating, the system will physically locate the consumer based on their check-in identification and then send the corresponding early alert based on a calculated time in relation to their distance from the restaurant. Consumers will now have the ability to check in for their restaurant reservation from anywhere; they no longer have to be present at the restaurant. or disclose their phone numbers. Consumers can check in for reservation at the designated time and then go pursue whatever activities they wish until the seating assignment is ready. At a pre-defined or calculated time based on customer distance from location, before their table is ready, the system will automatically send the consumers a paging alert to notify them that their tables will be ready within a calculated time or to proceed to the restaurant. Consumers can check in and then go shopping, browsing, or attend any other engagement they desire during that traditional waiting time that will no longer be there. This will eliminate one of the most bothersome nuisances associated with dining out and greatly improve consumers overall disposition while dining out.

This invention also increases the consumer control when reviewing/rating an experience and provides more granular control for who they may want to leave a review/rating for (issue [08]). Consumers select a certain restaurant from the menu, and then will be shown a list of all current server staff presently working with a rating next to their name. The historical rating is derived from consumers who have previously left a review/rating for that specific server based on past interactions. Consumers can then select a particular server from the list and review in greater detail all of the reviews left in the past for that server. This will provide a summary analysis of how the server works, what are their strengths and weaknesses, how they deal with errors and conflict, how quick they work, how attendant they are, etc, This process contains a built-in sustainable growth model that produces a revenue stream on the system's back-end through exhaustive analytics by learning of the user's needs.

By employing a system that reviews/rates servers individually, the rating record may become an entity for hospitality employment opportunities and matching. This will ensure that servers conduct themselves professionally at all times and work to the best of their ability. Should they look for other employment, members can now reference this platform (issue [08]).

3. Discussion of the Background

The problems noted above are resolved in the present invention with seamless device pairing setup, location-neutral paging, real-time communication system, and single repository rating system. In accordance with the present invention, communications between the two parties are facilitated using a command line interface, and rating verification is accomplished using customer-staff association key and based on rating impact factor.

The communication system of this invention allows the direct transmission communique between the customer and their it staff during their dining experience. This real-time communication system allows the customer to directly contact their server with any needs they may have during their time dining; for example if they need service, receive order updates, request a beverage refills alcoholic beverages, speak with a manager, request the check, etc.

The invention transmits two-way communications between customers and their servers. This two-way communication platform allow customers to send short messages directly to the wait staff attending to them during their meal from the convenience of their personal mobile device. Never before has a customer been able to directly request service without physically speaking with a member of the wait staff. In addition to the ability to directly attend to the needs of the customers exactly when they are needed and requested, no time will be wasted between trips back and forth to see whether service is needed at the tables. One of the advantages is also in the ability to not oversaturate customers with too much attention. This ensures hat wait servers are efficiently utilized at the table when they are needed. In essence, this communication system will effectively work better the more crowded and busy the restaurant is.

Mobile devices can communicate with one another using wireless network or peer-to-peer radio frequency communication. Messages are transmitted to the recipient device, which are progressively stored on the server as they are received. With progressive storage, the recipient has the option of rendering the message as received or reviewed, and the server has the ability of coordinating messages exchange and keeping a record of the messaging time of delivery. In addition, customers and staff may communicate with each other “live”, when messages are synchronously transmitted and rendered in real-time with respect to one another. Alternatively, users may communicate with each other asynchronously by sending messages back and forth by time-shifting the review of received messages.

4. Devices Pairing Solutions

The BUMP technologies introduced in [0010] requires physical bumping of devices, and thus it demands an actual touch of mobile phones to facilitate data and media transmissions between devices. Such restriction imposes physical limitations. To allow contactless communications between devices, the following invention is introduced.

There are two types of energies produced by mobile devices. Thermal heat in which microwave radiation produces dielectric heating which detects heat induced by the electromagnetic field. Thermal sensors absorb radiant heat and can sense a wide range of wavelength. Whereas in non-thermal, the communications protocols used by mobile phones often result in low-frequency pulsing of the carrier signal that can be converted into energy. The emitted frequencies can be captured by a sensing part and made public.

The energy sensing part receives radiant (thermal/non-thermal) energy transfer from an object to be measured that detects an amount related to energy received or released by the energy sensing part from or to an object measured based on the quantity of energy detected based on proximity matrix.

In addition, the camera and the speaker of mobile phones can serve as input signal detectors. In the case of camera light detector, light normally enters through the camera lens, then passes to the camera sensor, which receives the information and translates it into an electronic signal. In the case of speaker, an ultrasonic pulse from the speaker can be generated in a particular direction. If there is an object in the path of this pulse, part or all of the pulse will be reflected back to the transmitter which can be detected through the receiver path. By measuring the time difference between the pulse transmitted and the echo received, it is possible to determine the devices distance from each other, and those with the closest distance are authenticated and paired.

### BRIEF SUMMARY OF THE PRESENT INVENTION

This summary is provided to introduce simplified concepts of device detection and notification which is further described in the Detailed Description. This summary is not intended to identify essential features of the claimed subject matter, nor is it intended to use in determining the scope of the claimed subject matter.

This invention relates to a communication services that enables client communication devices to pair and communicate with other devices in either real-time or time-shifted mode. In the time-shifted mode, pairing requests and messages are retrieved and progressively rendered from data storage. Devices are paired progressively and messages are routed progressively as they are transmitted to the recipient device or storage server, which progressively stores pairing requests and the messages as they are received.

The uniqueness of the model is the communication system driving the messaging platform. The client communication devices are programmable devices, such as mobile and desktop computers, capable of running the communication application. The system will also be accessible by the above devices via the web app. The web app will be a web page designed to render well on smartphones. Client devices must have internet access to run either the app or web app. This includes WIFI or a 3G or better smartphone data connection.

The waiter/Hostess/management processes may be accessible through a mobile device, webpage, or through a central station.

Contactless (touch-less) pairing between devices is accomplished using heat sensing solutions. With lack of heat sensing solutions, devices can be paired at close proximity by using infrared radiation or optical/audio signal detection wherein the output of the speaker or the camera can be manipulated to recognize signals, frequencies, pitches, or shapes (such as images, barcodes) that are corresponded between to-be-paired devices.

### BRIEF DESCRIPTION OF THE DRAWINGS

The foregoing advantageous features of the invention will be explained in greater detail and others will be made apparent from the detailed description of the present invention which is given with reference to the several figures of the drawing. The same numbers are used throughout the drawings to reference like features and components:

FIG. 1 is a block diagram of a communication services network in a communication system in accordance with the principles of the present invention.

FIG. 2 is a block diagram for establishing communication and synchronizing connectivity between devices.

FIG. 3 is a dataflow diagram showing a configuration of a portable device detects another device and issues an activation (pairing) signal utilizing geographic location can be implemented.

FIG. 4 is a dataflow diagram showing a configuration of a portable device detects another device and issues an activation (pairing) signal utilizing QR codes possible implementation.

FIG. 5 is a dataflow diagram showing a configuration of a portable device detects another device and issues an activation (pairing) signal utilizing the Bump technology can be implemented.

FIG. 6 is a dataflow diagram showing a configuration of a portable device detects another device and issues an activation (pairing) signal utilizing NFC tags can be implemented.

FIG. 7 is a block diagram demonstrating plurality based connectivity using a controller to broadcast messages from one element (device) to a group of elements (i.e., devices).

FIG. 8 is a dataflow diagram detailing how a message-based notification and alert system between two entities can be implemented. kd

FIG. 9 is a dataflow diagram showing a process example of waiter assignment to a dining table and the messaging system that can be implemented.

FIG. 10 is a dataflow diagram depicting the messaging and notification system which occurs when a customer is to be placed on a waiting list and an example process of the alert structure that can be implemented.

FIG. 11 is a dataflow diagram showing a process example and a messaging system of impairing or inactivation of two device entities.

FIG. 12 is a dataflow diagram delineating an example process and a procedure for staff review and rating where every reviewer (e.g., customer) may alsd have a rating power known as impact factor on the overall rate of the wait staff.

FIG. 13 is a flowchart illustrating non-exclusive embodiments of the operation of the communication services network in accordance with the principles of the present invention.

FIG. 14 is a block diagram depicting a configuration of a portable device detects another device and issues an activation signal utilizing heat radiation and frequency intensity based on proximity server.

FIG. 15 is a block diagram illustrating a non-exclusive embodiment of the customer's communication with the principles of the present invention.

FIG. 16 is a block diagram illustrating a non-exclusive embodiment of the waiters communication with the principles of the present invention.

FIG. 17 is a block diagram illustrating a non-exclusive embodiment of the manager's communication with the principles of the present invention.

The following figures are presented to illustrate non-exclusive example embodiments of the displays based on the present invention. These figures are meant to help the one skilled in the art visualize the applicability of the present invention. Specifically:

FIGS. 18-26 are non-exclusive example embodiments of the customer displays and instructional steps within the principle of the present invention.

FIGS. 27-40 are non-exclusive example embodiments of the waiter displays and instructional steps within the principle of the present invention.

FIGS. 41-50 are non-exclusive example embodiments of the hostess displays and instructional steps within the principle of the present invention.

FIGS. 51-60 are non-exclusive example embodiments of the manager displays and instructional steps within the principle of the present invention.

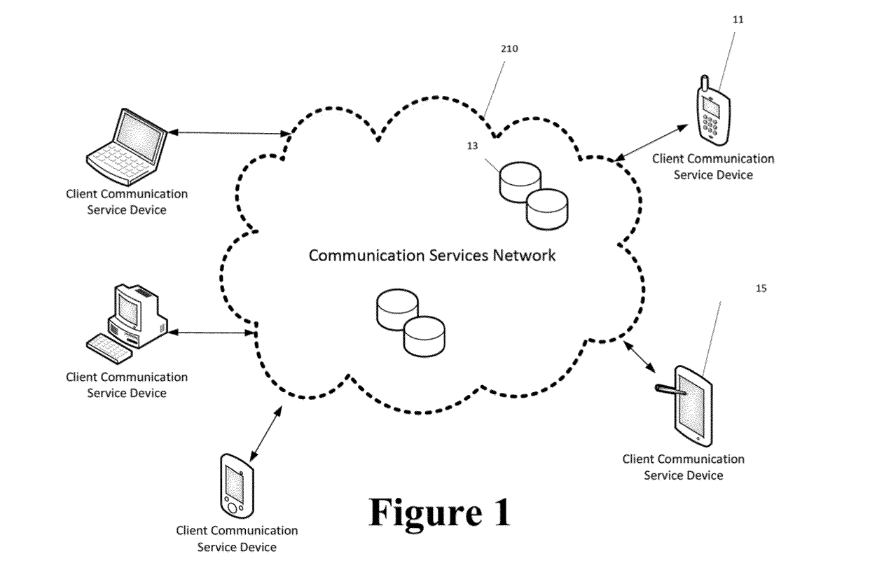

### DETAILED DESCRIPTION OF THE PREFERRED EMBODIMENTS

The following embodiments will be explained, divided into plural sections or embodiments, if necessary for convenience. Except for the case where it shows clearly in particular, they are not mutually unrelated and one has relationships such as a modification, details, and supplementary explanation of some or entire of another.

Furthermore, in the following embodiments, it is needless to say that an element (including an element step etc.) is not necessarily indispensable, except for the case where it is clearly specified in particular and where it is considered to be clearly indispensable from a theoretical point of view, etc.

It is appreciated that these drawings depict only illustrated embodiments of the invention and are therefore not to be considered limiting of its scope. The invention will now be described in detail with reference to various embodiments thereof as illustrated in the accompanying drawings. In the following description, specific details are set forth in order to provide a thorough understanding of the invention. It will be apparent, however, to one skilled in the art, that the invention may be practiced without using some of the implementation details set forth herein. It should also be understood that well known operations have not been described in detail in order to not unnecessarily obscure the invention. In all of the drawings for explaining embodiments, the same symbol is attached to the same member, as a principle, and the repeated explanation thereof is omitted.

The initial communication setup (e.g., IRDA, Wi-Fi, Bluetooth, cellular, etc.) is established based on devices pairing to establish an alert notification channel. Users can establish this channel using GeoLocation, QR code, device bump, NFC, or any other pairing/synching technologies. For instances, two users can pair their devices by using RFID, QR Code, among other. A unique identifier is sent to the to-be-paired device(s) which may include the image and location of the sender. The recipient device may pull down the other sender's information from the servers and displays it on the device. Device users then confirm the pairing.

Users can also sync their devices based on geographic location (GeoLocation). Here the customer selects the restaurant and then selects their particular waiter from the active list. The customer's device sends a pairing request to the server which is then forwarded to the waiter's device. The waiter confirms the request and the pairing are established.

Referring to FIG. I, a block diagram is shown of a communication system used in cooperation with a communication services network 210 of the present invention. The communication services network 210 includes one or more server clusters 13. One or more client communication service devices (i.e. 11, 15, etc.) are coupled to the communication services network 210. In various embodiments, the communication services network 210 is either heterogeneous or homogeneous. The client devices may be any type of communication device, such as telephones, including cellular or mobile phones, any type of computer, including desktop, laptop, notebook, netbook, or tablet computer, or any type of radio based communication device.

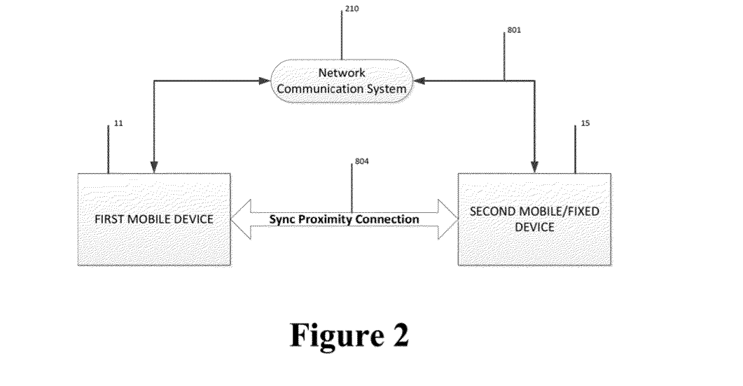

FIG. 2, Device Synchronization Diagram, depicts pairing initiation between two devices. It illustrates communication system 801 including a first mobile device 11, a second mobile/fixed device 15, and a communication network 210. As illustrated in system 804, a synchronous connection exists between the devices or asynchronous time-shifted connection if the staff device is inaccessible during the time the customer is pairing. As used herein, a synchronous connection means that a connection for purposes of jointly executing a particular task has been established at the same time. The connection is established, typically over network 210, upon the detection of a pairing request. Detection of a synchronous pairing request involves detection of complementary signals at client devices.

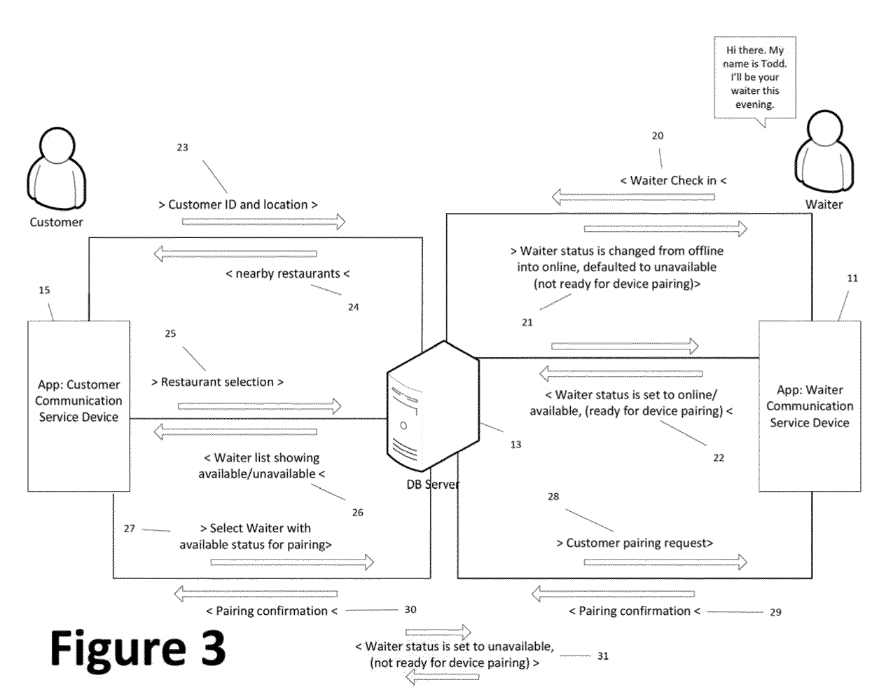

FIG. 3, GeoLocation Pairing Dataflow, details the process by which a customer selects the waiter and initiates a device pairing sequence between the customer's device and the waiter's device. This figure additionally clarifies the process by which waiters go through to ready their device to accept customer's device pairing requests. In the embodiment the waiter uses process 11 to clock (check) in at the restaurant where the system sends command message 20 to DB server 13. DB Server 13 changes the waiter's status from offline (offline is the state set when a waiter checks/clocks out) to online. The DB server 13 then issues a command to process 11 requesting an update of waiter's process 11 status to online. Process 11, once set to online, it is issued command 21 to default to unavailable, thus closing the port on accepting any messages from customer's device process. Process 15 receives message 26 showing status of waiters' list. Effectively, the waiter process 11 online status has two sub-types: unavailable and available. Unavailable status describes (may be displayed grayed) the waiter process 11 not ready to receive incoming pairing requests from customer process 15. When the waiter is ready to pair the device with the customer's device, s/he sets process 11 status to available by issuing command 22 to DB server 13. DB server 13 broadcasts message 27 accepting incoming pairing requests. DB server 13 creates system logs of the communication messages and broadcasts them to clients.

The customer process 15 initially sends its ID and location by issuing command 23 to DB server 13 which returns nearby restaurants by issuing command 24. Customer selects the restaurant of interest by issuing command 25 to DB server 13. DB server 13 returns the list of online waiters by issuing commands 26 to process 15, indicating currently working waiters with initial status to unavailable to deflect unsolicited requests for device pairing. Once the waiter status is set to available, the client process 15 issues command 27 to component 13. Component 13 logs and issues command 28 to the waiter's process 11. Upon confirmation, process 11 issues commands 29 and 30 pairing confirmation, recorded by DB server 13 and forwarded to customer's process 15 by issuing command 30. Component 13 logs the customer-waiter device pairing along with customer ID, waiter ID, date and time. A service alert channel is now established between the customer's and waiter's devices. Subsequently, the status of waiter process is set back to unavailable for device pairing by issuing command 31.

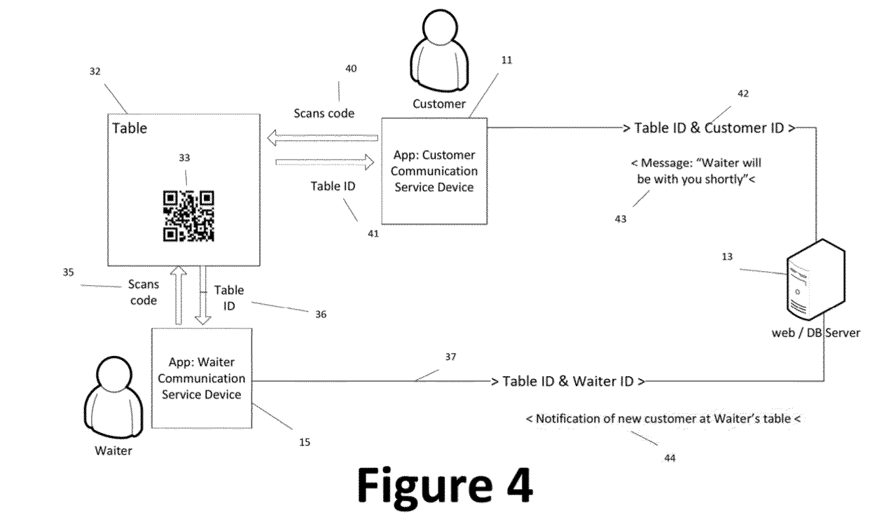

FIG. 4, QR Code Pairing Dataflow, details the process by which a waiter assigns themselves to a table by scanning the unique QR code. The barcode can be affixed to a table, among many other possibilities. (Note that the customer's phone must have an app capable of scanning QR codes; either a basic QR reader app which will pull up the web app, or the OR reader built in to the full app). This figure further clarifies the process through which the customer pairs her device to a waiter's device by scanning the same QR code. Each table 32 has a unique QR code 33. Tables may be registered on the server 13 with their unique QR code 33, registered to a particular restaurant. Each QR 33 code is universally unique. A waiter uses process 15 to scan the QR code 33 associated with a table 32 by issuing command 35. The QR code issues Table ID 36 to process 15. Process 15 forwards (the waiter's ID and the Table ID) message 37 to component 13. Component 13 logs the incoming message containing table ID, waiter ID. Upon seating at the table, customer using process 11 scans the QR code 33 and records Table ID 41. Process 11 forwards customer ID and Table ID 42 to the server 13. Component 13 detects incoming message 42 and looks up which waiter is associated with that table. Component 13 records an active customer-waiter association in the database, issues message 43 to the customer, which could be a confirmation message, “waiter will be with you shortly.” Component 13 issues message 44 to the waiters process notifying that customers are now seated at the table. A service alert channel is now established between the customers and waiters processes, 11 and 15 respectively. A channel of communication is thus established between the customer and waiter's devices.

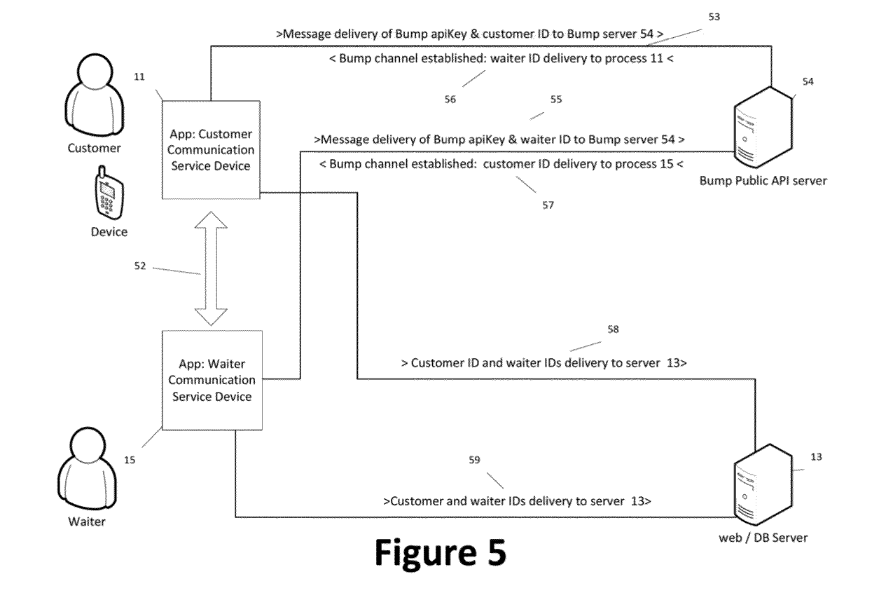

FIG. 5, Bump Pairing Dataflow, details the process by which a customer and waiter pair their devices through the use of the Bump public API and associated establishment of a Bump data channel. Here the customer and waiter bump devices while the bump interface is active. The app contacts the Bump public API and establishes a match based on a combination of IP address, GPS coordinates time. With a Bump based matched established, the app contacts the servers with the Customer ID and Waiter ID and establishes a channel of communication for further alerts. The customer can now send the waiter service request alerts.

In details, after initial ID transfer via Bump, the devices contact the server to establish a waiter-customer association. Process 11 and process 15 open a bump interface built into the application API. Once devices are physically bumped within a geographic proximity 52, process 11 issues command 53 containing customerID, Bump API key, GPS location, IP address and timestamp, to the Bump public API server 54. Process 15 also issues command 55, waiter ID Bump API key, GPS location, IP address and timestamp, to the Bump public API server 54. The Bump public API server 54 establishes a match based on a combination of IP address, GPS location and timestamp. The Bump server 54 then establishes a communication channel between the customer's and the waiter's devices, and issues message 56 containing Waiter ID to process 11, and message 57 containing customer ID to process 15. Step two of this process involves process 11 issuing message 58, containing customer ID and waiter ID, to server 13. Process 15 concurrently issues message 59, containing customer ID and waiter ID, to server 13. Component 13 compares messages, registers a Bump-based pairing match, and records the customer-waiter association in the database. A service alert channel is now established between the customer's and waiter's devices.

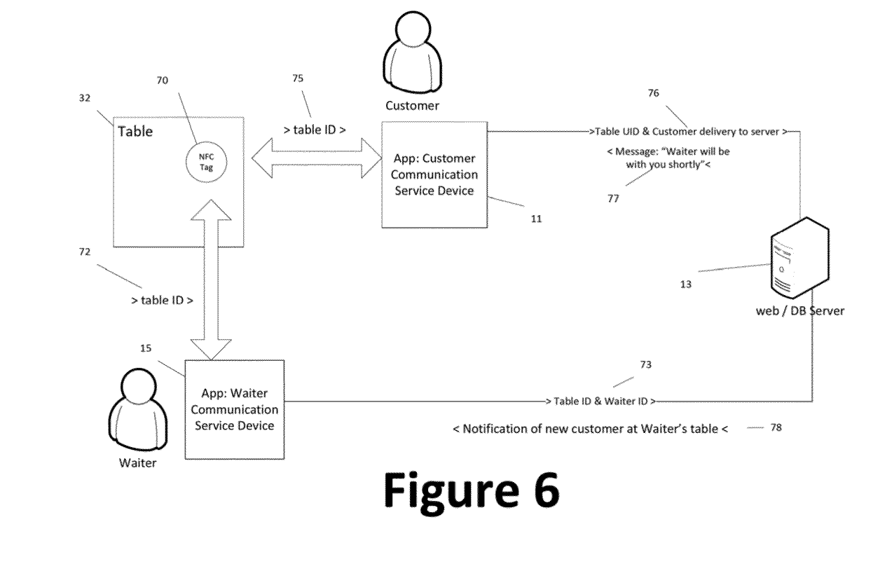

FIG. 6, NFC Tag Pairing Dataflow, details the dataflow for pairing of a customer and waiter's devices utilizing NFC tags. Specifically depicted is the process by which a waiter assigns themselves to a table by scanning a unique NFC tag. Here the customer places their phone onto a NFC sticker on the table, among many other choices. (Note that the customer's phone must be capable of reading NFC tags.) The NFC tag is associated with that table ID. This figure further clarifies the process through which the customers pair their device to waiter's device by scanning the same NFC tag. Each table 32 has a unique NFC tag 70. Tables are registered on the server 13 with their unique NFC tag 70, registered to a particular restaurant. Each NFC tag 70 is universally unique. A waiter assigns himself to a table by opening the process 15 and scans NFC tag 70 associated with table 32. The NFC tag issues message (Table ID) 72 to process 15. Process 15 forwards message (Waiter ID and Table ID) 73 to component 13. Component 13 logs the incoming message containing table ID and waiter ID. Upon seating at the table, customer's process 11 scans NFC tag 70 and records Table ID 75. Process 11 forwards customer ID and Table ID 76 to the server 13. Component 13 detects incoming message 76 and looks up which waiter(s) is associated with that table. Component 13 records an active customer-waiter association in the database, issues message 77 to the customer, which could be a confirmation message or waiter will be with you shortly. Component 13 issues message 78 to the waiter's process 15 notifying that customers are now seated at the table. A service alert channel is now established between the customer's and waiter's processes, 11 and 15 respectively. A visual indication identifying the particular customer or waiter is established at display devices of the other communication devices (e.g., a photographic image of the customers and waiters).

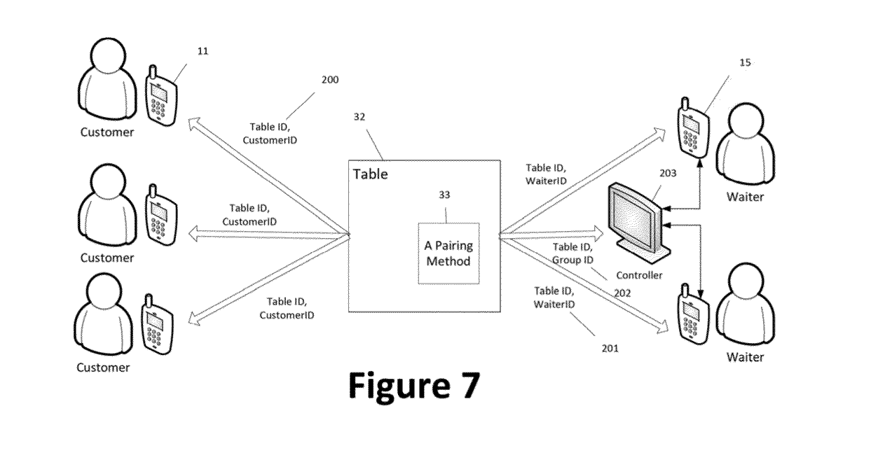

FIG. 7, Plurality Pairing Data low, presents a plurality of elements where each element (e.g., client device 11 & 15) is configured to perform an independent process; a controller 203 configured to control the plurality of elements; and a front end shared by the plurality of elements (using Group ID of linked waiters) and configured to perform communication, wherein at a time of interaction, the controller 203 allocates to the plurality of elements different processes for communication. The controller 203 represents an initiation of a data broadcast from a device to multiple devices (e.g., a customer message is broadcast to multiple waiter devices). Each of the elements may perform a process based on a corresponding action/operation, have element-based identification information, and have a function of performing communication. Each participating element sends its action events to server 13. The controller controls an operation of each of the elements unless they need to be distinguished individually.

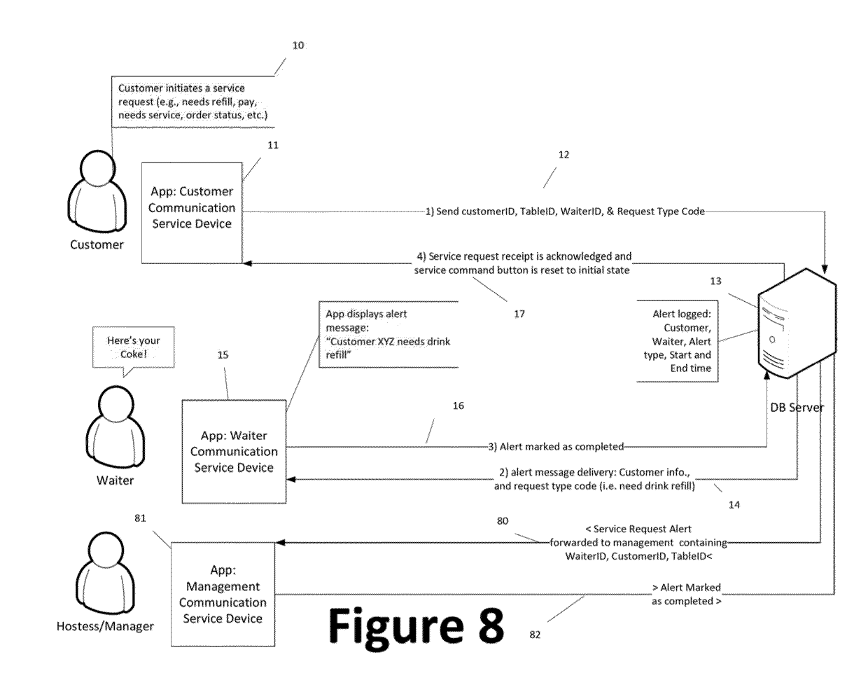

FIG. 8, System Alert Dataflow, shows an embodiment of client (aka customer) and server (aka waiter) command notification service. It depicts a customer initiating a service request alert by clicking on any one of the commands in process 11. Once a pairing is established, a customer can alert a waiter through a messaging system if she needs service. The commands on the process 11 are configured with preset options which can be modified to include any additional commands. The communication service process 11 illustrates a customer initiates a request using a computing-based device (portable or stationed) and issues a command 10 (e.g., need service code). A service command 12, containing customer ID, waiter ID, Table ID, and the service type, is forwarded to the DB server 13. Component 13 creates a log of the service request with date and time, and resolves any conflict, message duplication/repetition. Thus, prior to logging and forwarding the request to the waiter, the DB server resolves repeated or duplicated requests (e.g., multiple clicks within a short period of time). DB server 13 then determines the status of the service request and forwards the message 14, including customer information and Table ID, and request type to the waiter process 15, and marks the client message as unfulfilled. The waiter reads the alert on the device and takes a command-line action accordingly which is captured and logged by DB server 13. After the waiter fulfills the request s/he marks the alert as completed on device 15. The reply message 16 is detected at component 13. Component 13 creates a log and forwards the message 17 to the client device 11. Component 13 resets the message alert on the waiter device 15 as fulfilled. If a predetermined amount of time elapses (e.g. 3 minutes), the request is forwarded to the hostess or manager, as such. In the event that a service is not attended within a certain amount of time, component 13 forward's the request to the Management Communication process 81 issuing message 80 of customer ID, Table ID, Waiter ID, alert type, and timestamp. The service request is marked as completed by issuing message 82 containing the ID of care taker and a flag. The alert is then cleared from the customer's device.

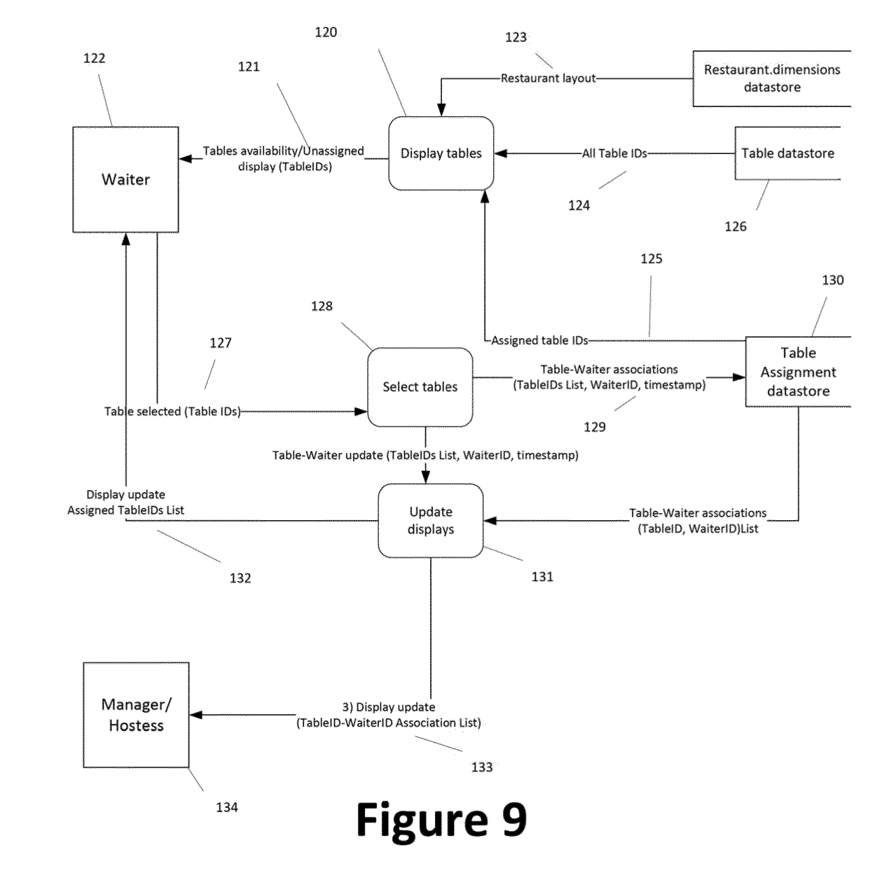

FIG. 9, Waiter-Table Association Dataflow, details an embodiment of the process by which a waiter is associated with the table(s) he is covering at the beginning of or during a shift. Process 120, upon being invoked by the waiter, receives table IDs in message 124 from data store 126, then correlates this list against the list of assigned tables (tables currently being covered by other waiters) via message 125 from data store 130. Waiter entity 122, upon receipt of message 121, selects the table(s) to be covered; issues message 127 to process 128. Process 128 receives this request, resolves any conflicts and logs these table-waiter association(s) and timestamp by issuing message 129 to data store 130. The table-waiter association is a record of a waiter covering a particular table and is used by later processes (see FIGS. 3-6) to determine waiter-customer pairing setup. Process 128 then issues an update command to process 131 Process 131 receives and broadcasts messages 132 and 133 to the waiter entity 122 and hostess entity 134, respectively, to update the waiter-table association record. This embodiment generally explains the communication process and is not meant to be exact and thus it solely explains the overall systems interaction.

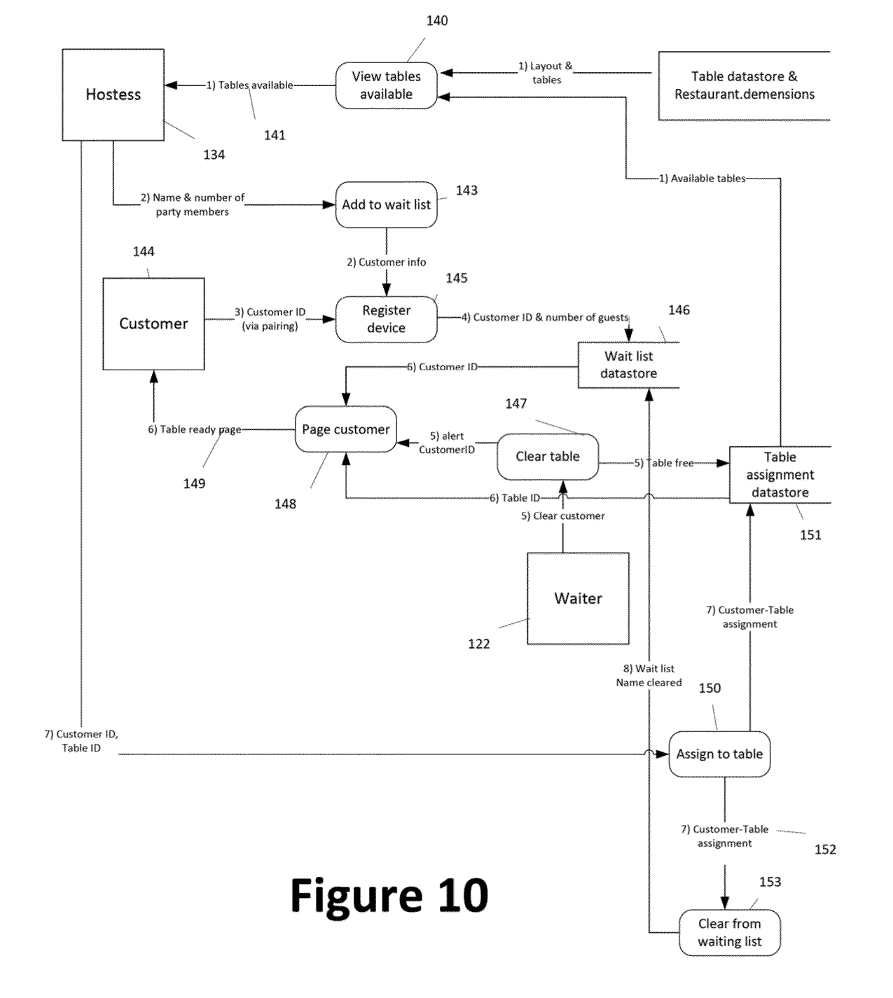

FIG. 10, Waiting List Dataflow, delineates an embodiment of the communication message exchange when a customer comes to a restaurant where there is a wait to be seated; specifically the add-to-waitlist and customer paging procedures. The messaging system facilitates customer notification when the table is ready. Device pairing establishment enables customers to check their waiting status (i.e. estimated time remaining), as well as receive an alert notification when their table is ready. Hostess 134 issues message 141 to view available tables to process 140. The hostess entity 134 then adds the customer to the waiting list via process 143. Customer entity 144 and hostess entity 134 initiate a device pairing via process 145 which in turn registers the customer in the waiting list data store 146. The device pairing may be accomplished using any device recognition technique, such as Bump, GeoLocation, NFC, QR Code, among any other technological solutions that facilitate synchronization/pairing between two computing devices. For instance, the hostess may have a QR codes or NFC tag enabled on her device that can be scanned by visiting customers which would automatically capture the customer's information for later wireless device notification.

Waiter entity 122 clears her table via process 147 which automatically triggers process 148. Process 148 pages the customer entity 144 through command notification 149. Hostess entity 134 associates the customer with the table assigned seating through process 150 which logs the customer-table assignment and timestamp in data store 151 Process 150 concurrently issues command 152 to process 153 which clears the customer from the waiting list data store 146.

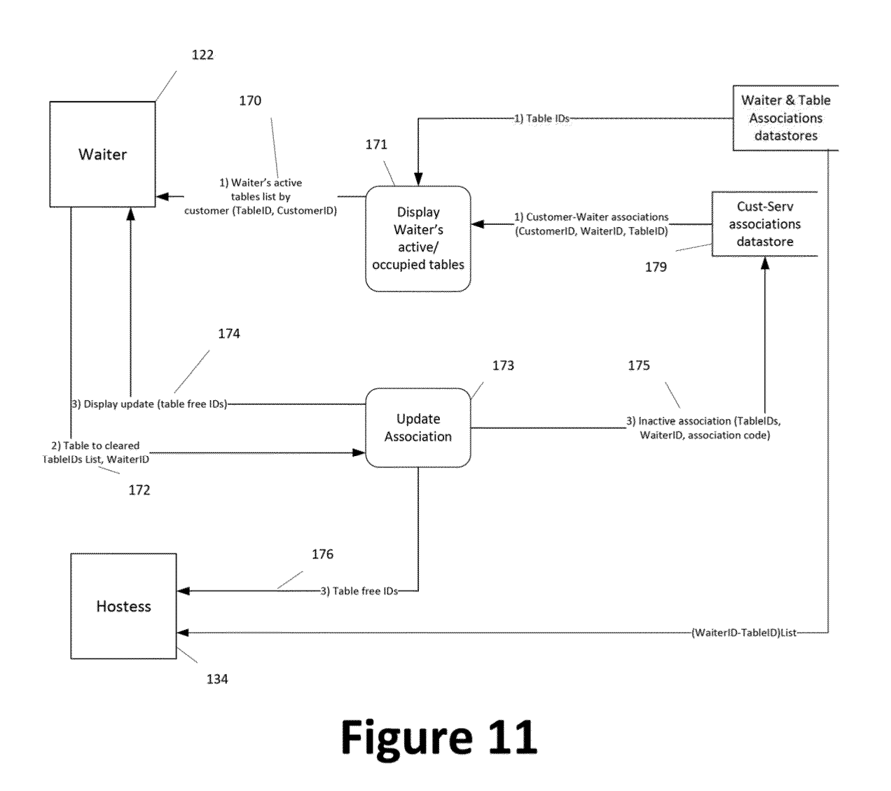

FIG. 11, Customer-Waiter unpairing Dataflow, shows an embodiment of the overall process of a waiter clearing a customer from his active customer-waiter associations, thus closing the customer-waiter service alert notification channel (as embodied in FIG. 8) and marking the table as available for a new customer. This process begins after the customer checks out of the restaurant. Waiter entity 122 views her active tables by invoking process 171 which in turn issues message 170 listing active table IDs. Waiter entity 122 clears table from customer association and thus marks a table as free by issuing message 172 to process 173. Process 173 issues message 175 of table-customer disassociation to data store 179. The customer-waiter service alert notification channel is now closed. Upon confirmation from component 179, process 173 broadcasts an update command to Waiter entity 122 and Hostess entity 134 by issuing messages 174 and 176, respectively. Process 173 also logs the completed seating details 177 to data store 178.

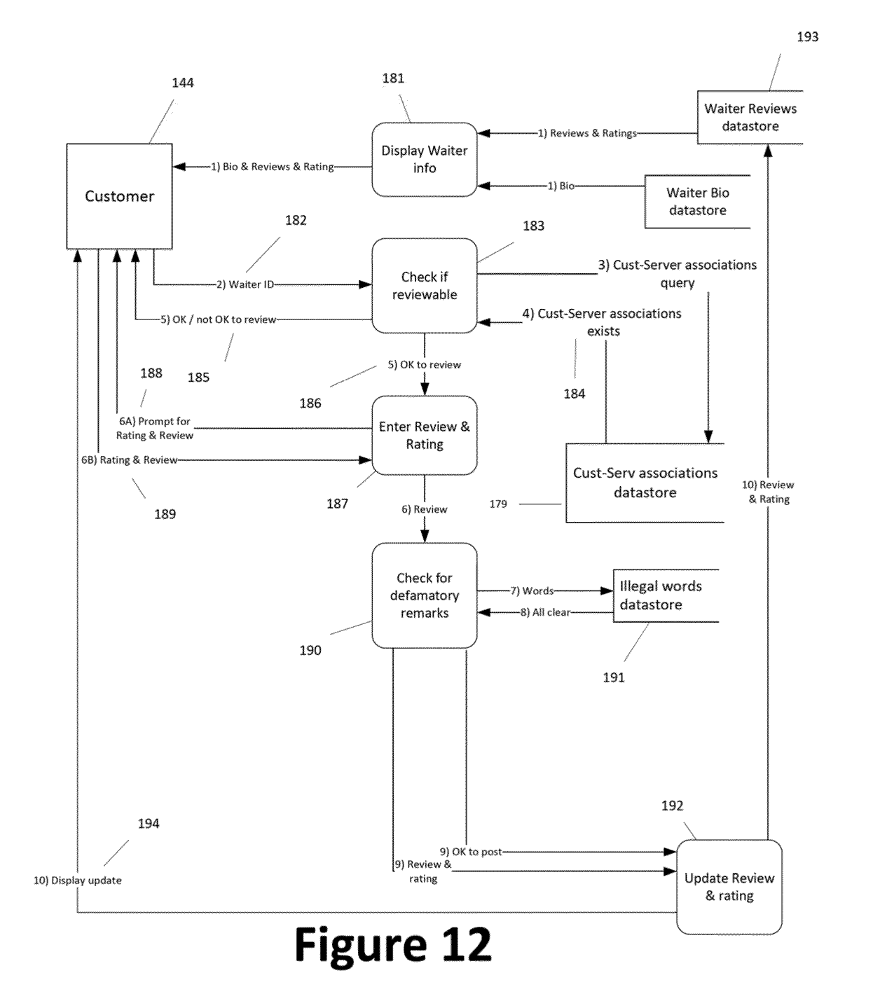

FIG. 12, Server Rating Dataflow, shows an embodiment of the customer procedure for rating/reviewing a staff, such as a waiter or a chef. Customer entity 144 begins this procedure by pulling up a waiter's information via process 181. Entity 144 initiates a review by issuing command 182 containing the selected waiter ID to process 183, which in turn checks to see if the customer actually had this waiter(s) serve them by querying data store component 179 (Customers can only rate waiters who have waited on them). If customer entity 144 has not had this waiter server them before, process 183 issues message 185 with the details that they are not able to leave a review for this waiter. Process 187 issues message 188 which prompt the customer to enter their rating and review. Customer entity 144 then enters her rating and review encapsulated in message 189 by process 187. Review is then forwarded to process 190 which checks the review for any defamatory remarks listed in data store 191. If the review passes this check, it is forwarded to process 192 which logs the review, rating, customer ID and timestamp to that waiter's profile in data store 193 as well as broadcasts display update command 194.

This invention also defines a rating impact associated with customers. The customer rating effect (known as impact factor) is based on rater history and past interaction. The “impact factor” is a measure reflecting the overall effect of the rater's feedback. For example, raters who gave sufficient rating history of excessively negative or positive feedback have an adjusted rate impact value. This value determines the relative importance and meaningfulness of the rate. The rating impact is a decimal interval [0-10] where 10 is mostly significant. The overall statistical rating formula is compounded independent variables based on past history of the rater, day of the week, time of the day, restaurant type, restaurant location rating, rater age, and rater's years of experienc., among others. For instance, the review is adjusted to account for the abovementioned variables, such as the case when the restaurant type impacts the opinion of the customers on feedback quality, or the time/day when the restaurant is normally busy.

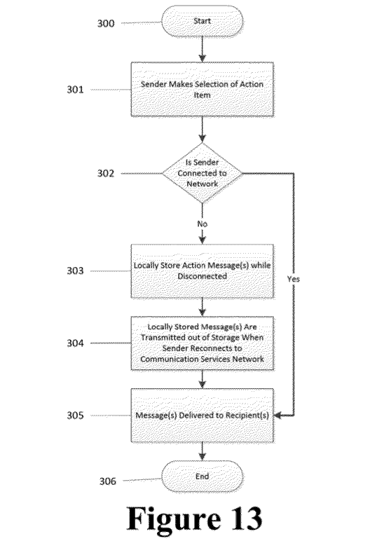

FIG. 13, Message Delivery Dataflow, illustrating the sequence for creating and transmitting messages from a client device. In the initial step 300, the user creates an action item (message) 301. As each action is created, the client application determines (decision 302) if the client device (e.g., 11) is connected to the communication services network 13 or not. If yes, then the message is delivered to the recipient per the steps outlined with respect to FIG. 8. On the other hand, if disconnected, typically because either the network is down, or the sender has wondered into a location with no or limited coverage, then the message(s) is (are) locally stored (step 303) at the client communication device. When connectivity with the network 210 is reestablished, the one or more messages are transmitted (step 304) out of storage. The messages are then delivered (step 305) to the intended recipient(s) per the sequence detailed above with regard to FIG. 8.

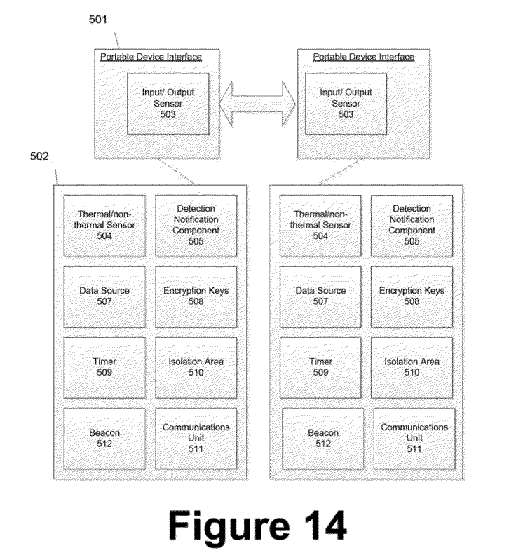

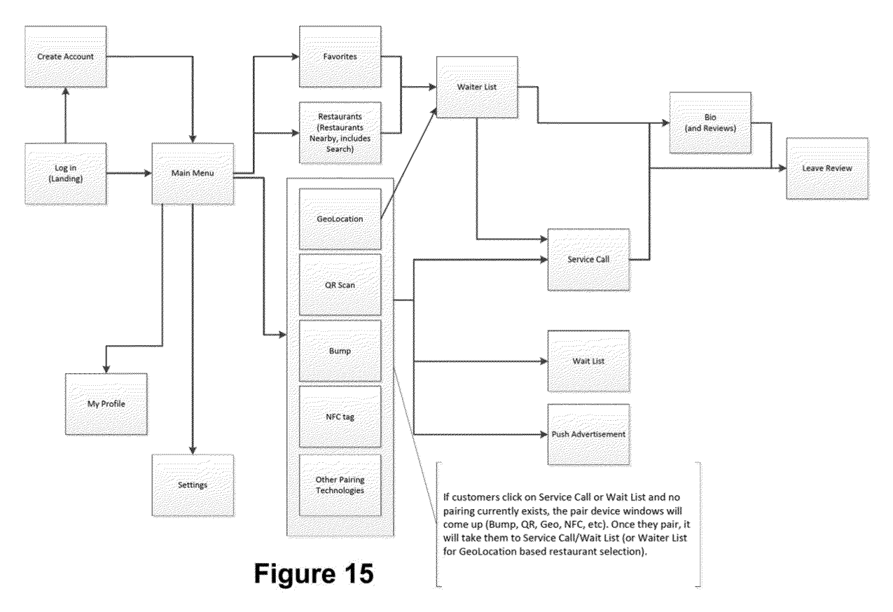

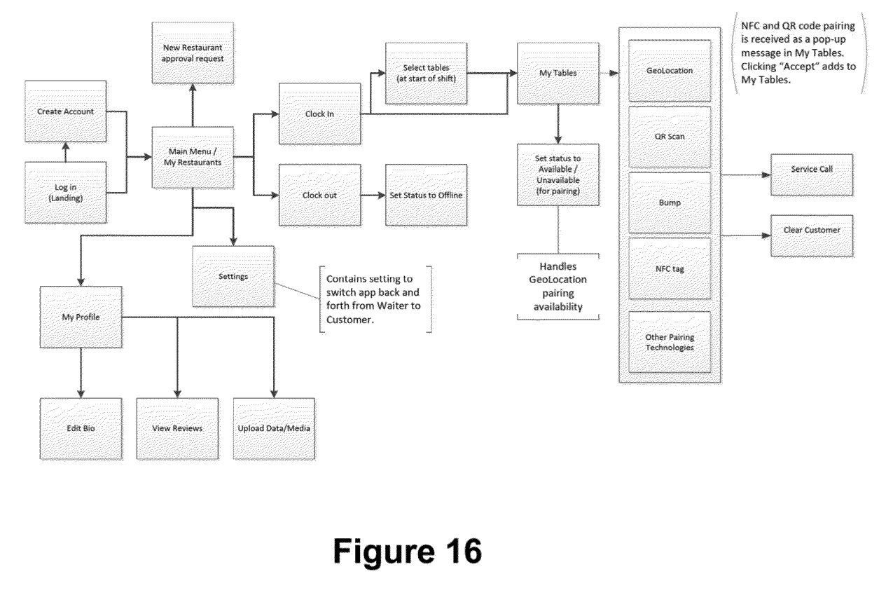

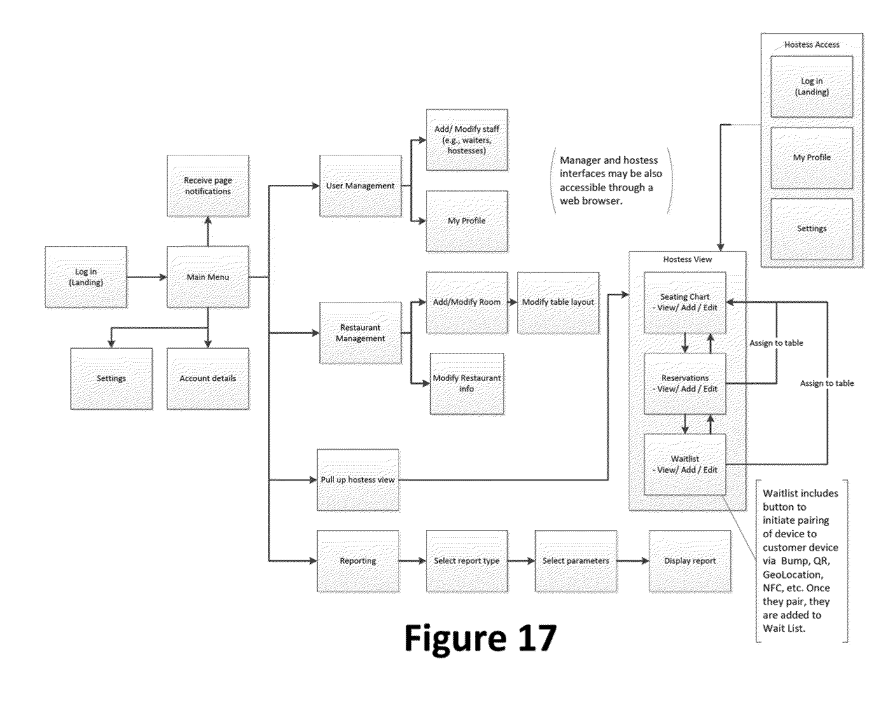

FIG. 14 details the process by which two devices are paired based on radiant energy, radio receiver, optical signal audio signal, or motion sensor signal. The mobile device 501 is comprised of an input sensor 504 (e.g., thermal/non-thermal heat) wherein the system upon receiving a signal from the input sensor, sends it via communications unit 511 which triggers beacon 512. Once triggered, beacon 512 sends a short-range signal to a nearby mobile device, the signal identifying the mobile device. Component sensor 503 (can be the inputs and outputs of camera, speaker sources) is configured to detect a pairing request between computing devices.

Portable Device Interface 501 is used as a mechanism for device recognition and signal detection. Portable Device Interface 501 can be implemented to send and receive data and instructions using any wireless communication technology known in the art, including technologies promulgated by groups such as the Bluetooth Special Interest Group, the Infrared Data Association (RDA), and the Near Field Communication Forum (NFC). It shows synchronous pairing connectivity according to proximity matrix indicated by Isolation Area 510. The data and/or instructions can be stored locally in Data Store 507 for manipulation and interpretation which is confined to the isolation area 510.

According to [20-22], a device may report its identification either to a server or to a neighboring device when it detects radiant energy, audio signal, optical signal, an image, or a motion picture from a neighboring device. It then emits a beacon signal 512 identifying itself to the neighboring device. A server may have a threshold of proximity and signal reference ranges. Each device registers its radiant energy or signal strength of its adjacent devices and those with the highest intensity/match will be registered and subsequently paired,

In an embodiment of radiant energy and signal detection notification, an energy sensor 504 in a mobile device detects energy of a neighboring device and issues an activation signal when the detected energy has a magnitude or proximity greater than a preset threshold. A detection notification component in the portable device then receives the activation signal and initiates communication with another device that detects a corresponding signal of the device and is configured for communication with the device. Timer 509 records the time of detection by component 503. While different time duration may potentially exist for each device, it can be approximately the same for each signal detected by another device. For instance, when the times associated with timestamps for both devices are subtracted from one another, the time duration cancels out, leaving the real time duration between detection.

Data transmission can be encrypted by Encryption Keys component 508. Notification of signal detection by devices is captured by Detection notification component 505. Radiant energy detection signal or shape detection occurs when two devices at the same place at the same time.

Another strategy utilizes the concept of a proximity server for asynchronous connection where each wireless device, communicating in peer-to-peer mode, can simply broadcast their data synchrony and registers its own energy/signal strengths with a proximity server. The proximity server can then mark the request as outstanding for pairing and waiters can pair their customers in accordance with the customer identification and location. The following example embodiment will further illustrate some parts of the invention.

### An Exemplary System

Some aspects of the described systems and methods and detection notification can be implemented in any number of different computing systems, environments, and/or configurations.

In an embodiment of signal detection notification, a light sensor 503 from the camera (or an ultrasound detector from the speaker phone) in a mobile device detects light (or ultrasound) of another device and issues an activation signal when the detected materials has a magnitude greater than a preset threshold. A Detection Notification Component in the mobile device then receives the activation signal and initiates communication with an additional device that detects a corresponding signal of the device and is configured for communication with the mobile device.

In another embodiment of signal detection notification, Sensor 503 in the mobile device registers its signal between the mobile device and the additional device. Sensor 503 provides the initiation of wireless communication between a mobile device and another mobile device. The Detection Notification component 505 then determines that a magnitude of at least equivalent to the preset threshold in the mobile device, and initiates the communication with the additional device.

Once a signal is detected, the timers in each of the devices are triggered that indicates when the contact was approximately detected. Detection notification component 505 can then determine if the heat/light/sound signal equals or exceeds a preset threshold. If it is determined to equal or exceed the preset threshold, the detection notification component 505 in either device can initiate communication the other device.

In another implementation, the mobile device can send a discovery query to find out if other registered devices are within range of the communication capability of wireless interface. If such device(s) exist and have a capacity to communicate, the device issues a discovery communication. The other device(s) can affirmatively answer the discovery communication. The mobile device can restrict its search for the other device by querying all of the registered devices in Isolation Area 510 to determine which devices have recently experienced a heat/light/ultrasound signal around the same time within a certain coincidence of the signal experienced by device. The mobile device can make public the timestamp generated by timer 509, and can query whether the other devices have detected a signal at or around the same time. Alternatively, the mobile device can query the other devices for timestamps associated with times in which they detected a signal and compare these to the timestamp associated with the detection created by timer 509.

In another possible implementation, the mobile device can query other devices of registered users at that location. If more than one device reports detection within the predetermined time window, the device may refuse to communicate with the reporting device(s). Otherwise, the mobile device may review the report and use information included in the report including, for example, information such as the location from Isolation Area 510, time from timer, or magnitude of the signal detected to confirm the identity of the other device.

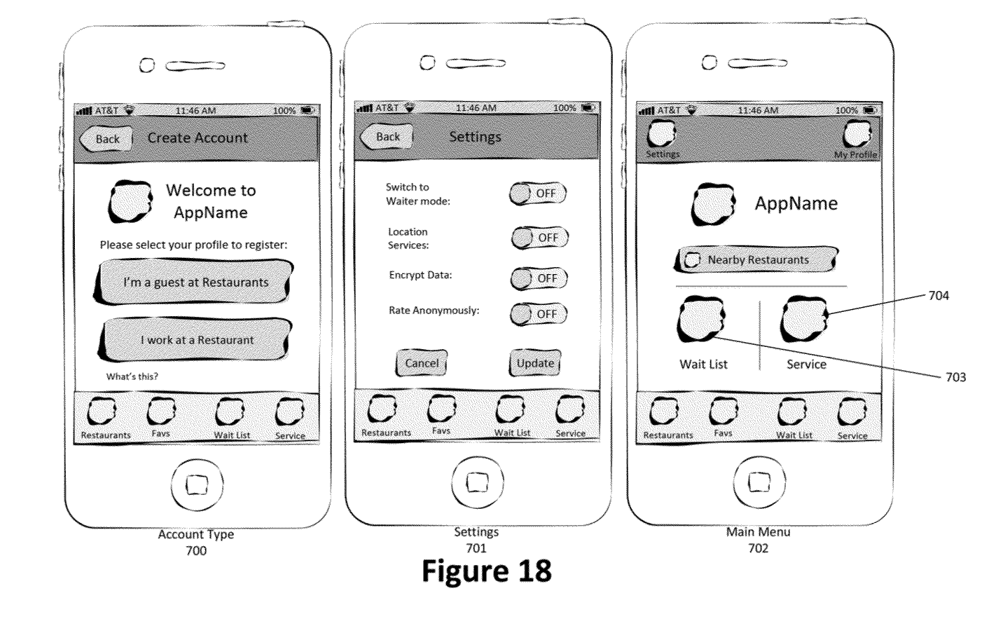

FIG. 18 describes an example embodiment of a customer's displays after logging on with the appropriate authentication. The account creation and authentication embodiments are not presented in this invention as they present the standard process of account settings and thus have no impact on this invention. Display 700 presents the option to log on as a customer or a staff. Display 701 presents the settings where a customer may rate anonymously, turn on their location services, encrypt data, or enable location services for accurate results. Display 702 is the customer main display or landing. Highlighted in the middle of the screen are nearby restaurants, directly pairing portable device with a hostess' “Wait List” process 703, and directly pairing portable device with a waiter using “Service” process 704.

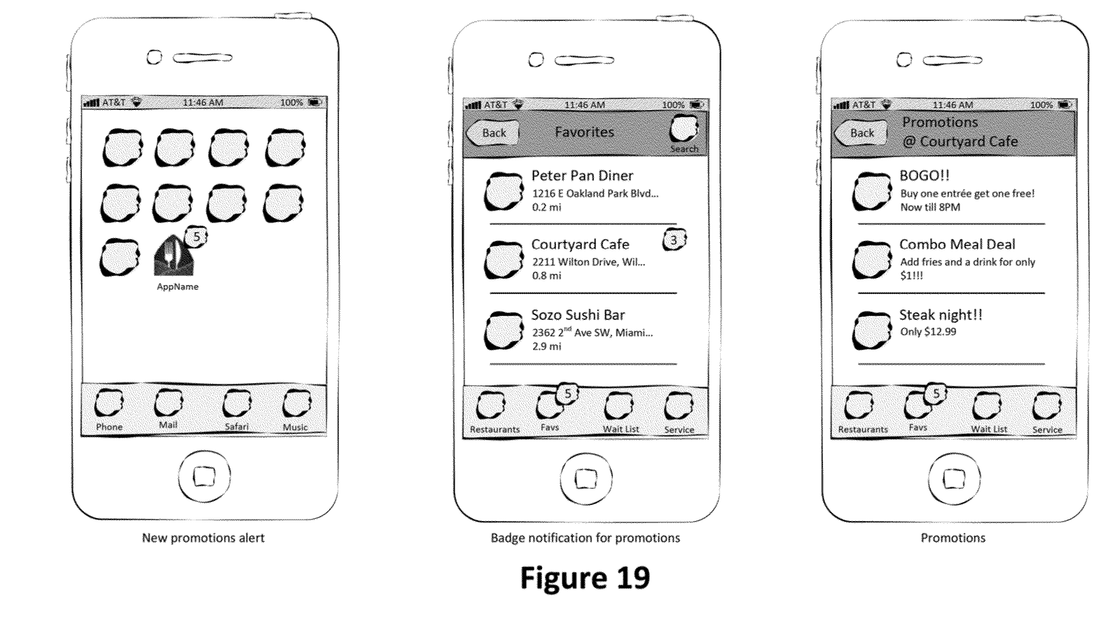

FIG. 19 depicts the process of tailored push notifications and promotions based on customer favorites.

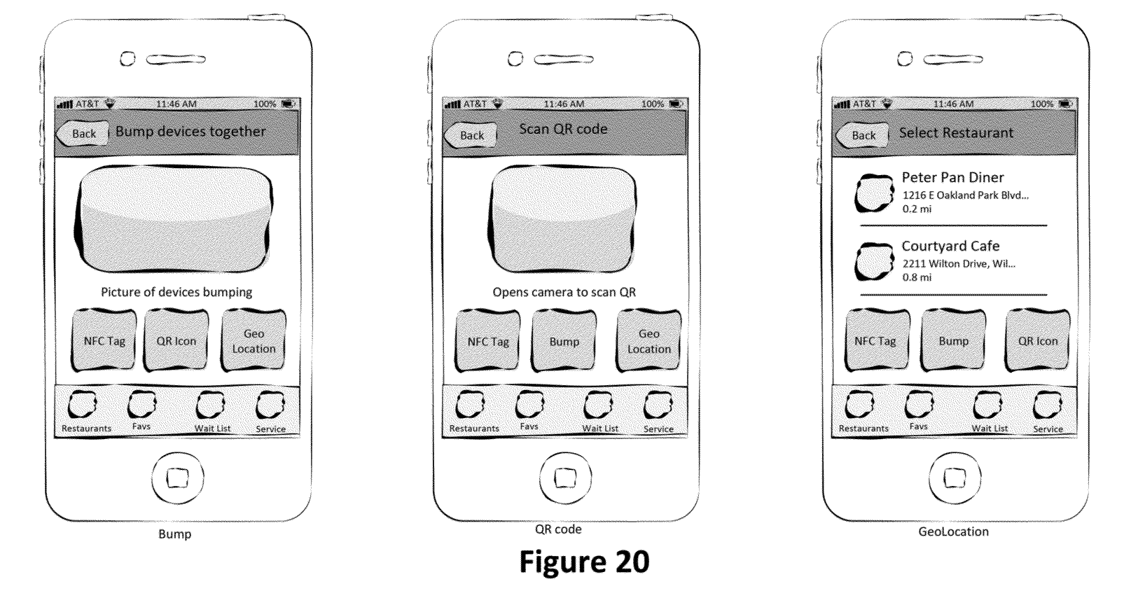

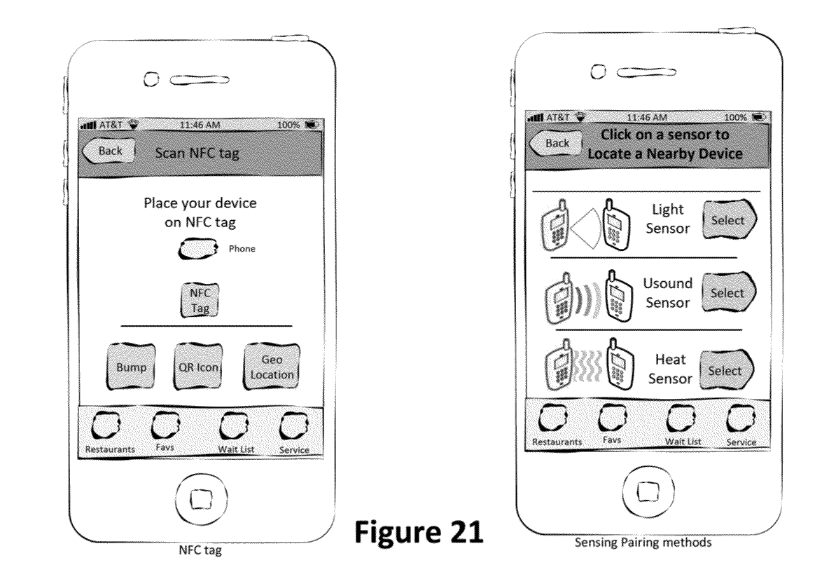

FIGS. 20 and 21 depict an embodiment of device pairing methods to pair customer's portable devices with the other computing devices once the user selects or clicks on processes 703 or 704.

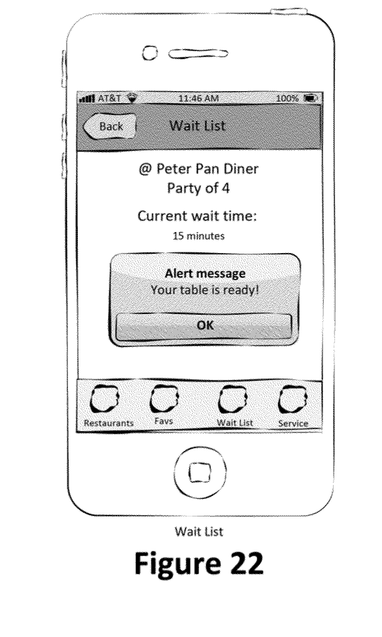

After pairing the device with a hostess's device, the customer can use the “Wait list” display in FIG. 22 to view the current wait time and receives an alert when the table is ready.

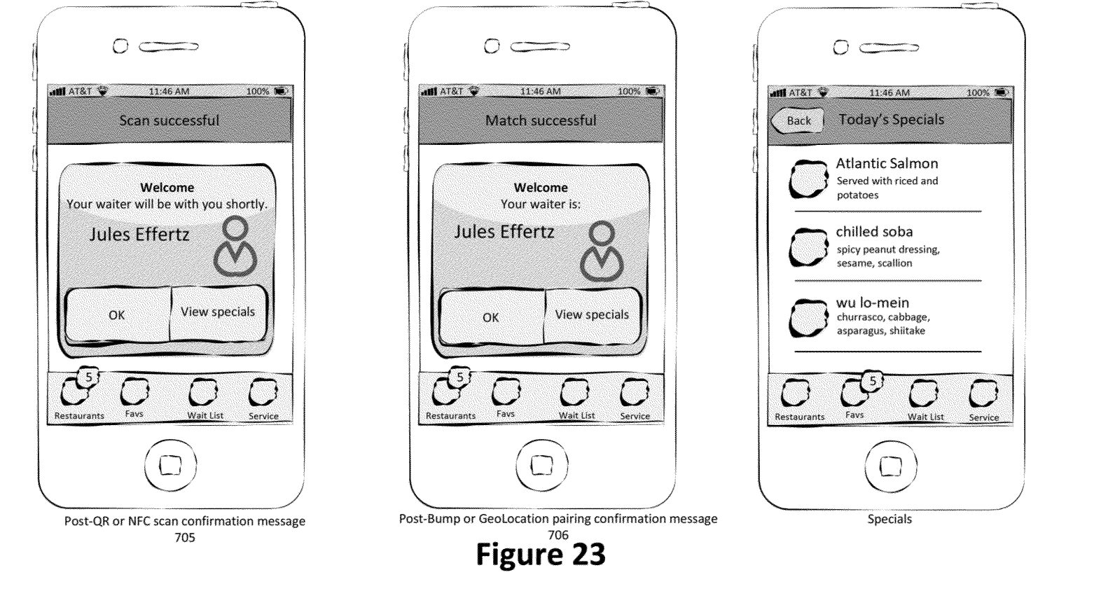

FIG. 23 depicts a Display 705 of a successful QR or NFC scan that automatically generates an alert displaying assigned waiter based on table-waiter association key. Display 705 preempts physical contact between customer and waiter. Display 706 depicts a successful bump using physical device bumping or GeoLocation based pairing where an alert with the waiter's name and picture is shown on the Display.

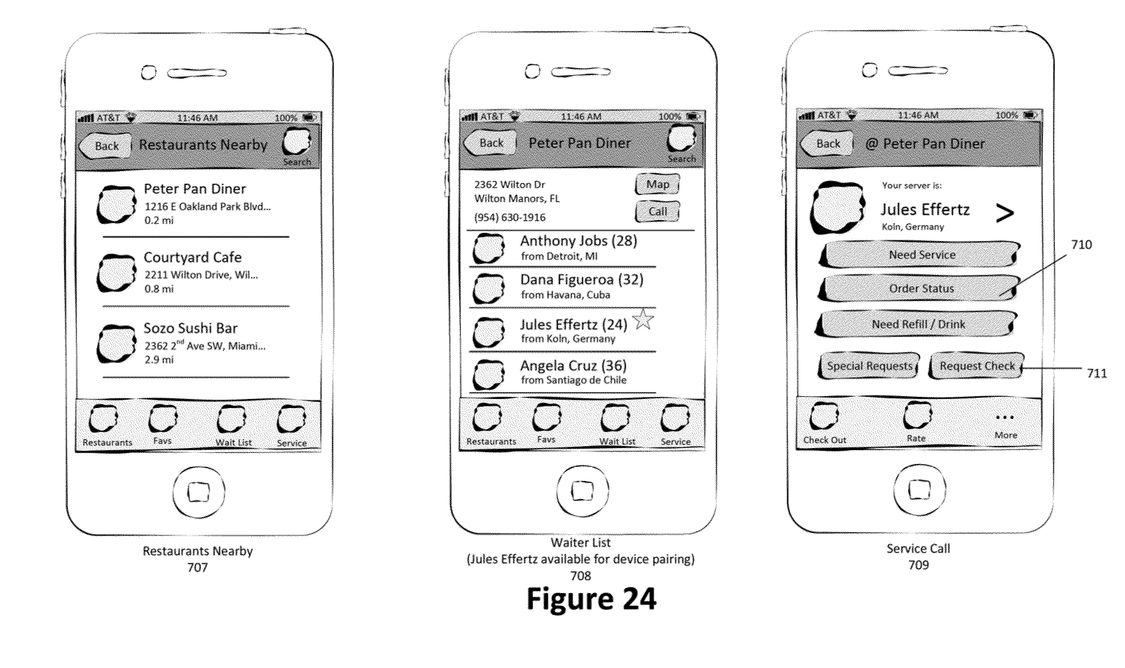

FIG. 24 illustrates a sequential displays starting with Display 707 depicting nearby restaurants or the restaurants options from the main display 702 in FIG. 18. This will result in Display 708 of waiters on duty. If a particular waiter's device is available for pairing, a select button is displayed next to their name. Once the user's device is paired with a waiter's device, she can communicate wirelessly by initiating service alerts as shown in Display 709.

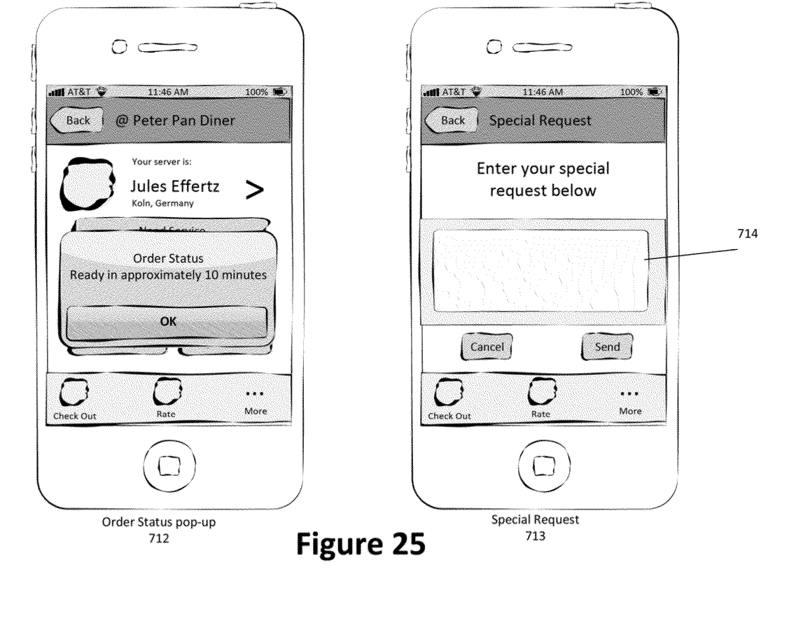

FIG. 25 depicts an embodiment of initiating a service request in Display 712 by clicking on order status 710 in in Display 709. Display 712 shows an alert of remaining time till order is ready. Display 713 allows customers to submit special request after clicking on component 711 in FIG. 24 and by typing texts in component 714 (e.g. “need salt”).

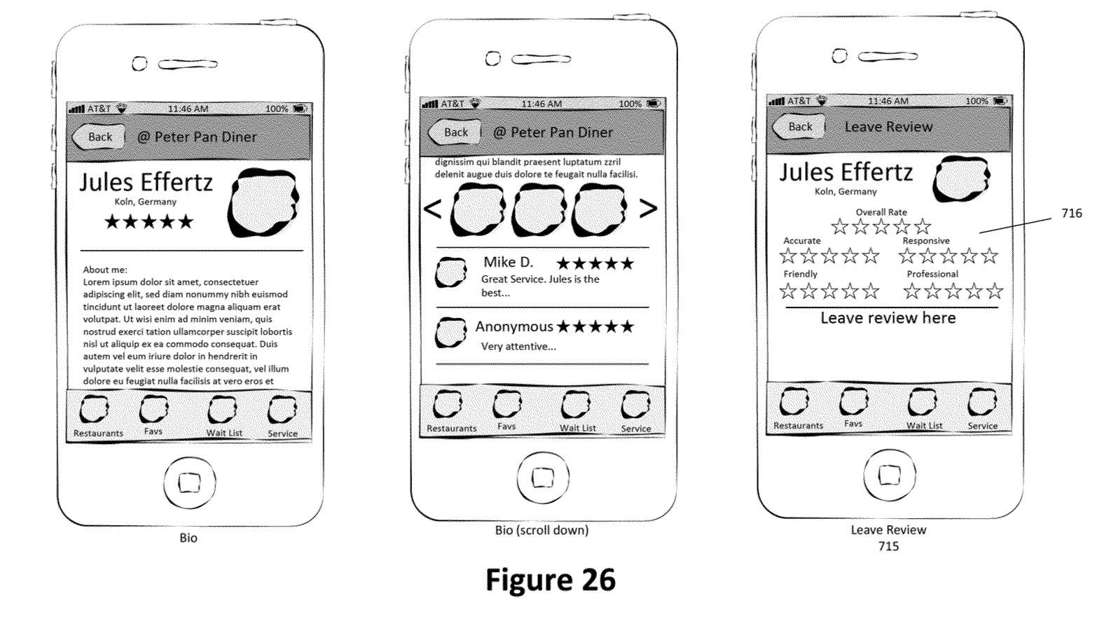

FIG. 26 depicts example embodiments of the views of the waiter's profile, which includes any public information, such as waiter's bio, ratings, pictures and individual customers ratings. Display 715 allows customers to leave their ratings and review for their waiter(s). Some examples of rating criteria are shown in component 706.

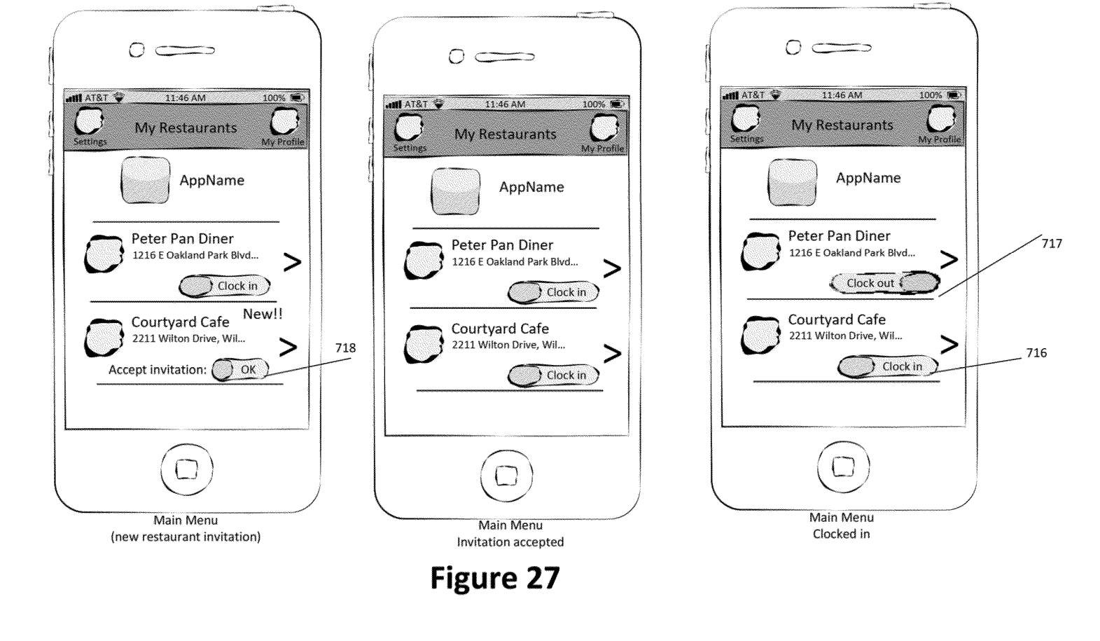

FIG. 27 depicts an embodiment of main menu displays of waiters upon logging on to the application. They can “clock in” using component 716 when starting their shift. The waiter may use component 717 to clock out at the end of her shift. The displays also show when a waiter is newly hired by a restaurant and an invitation is sent using component 718.

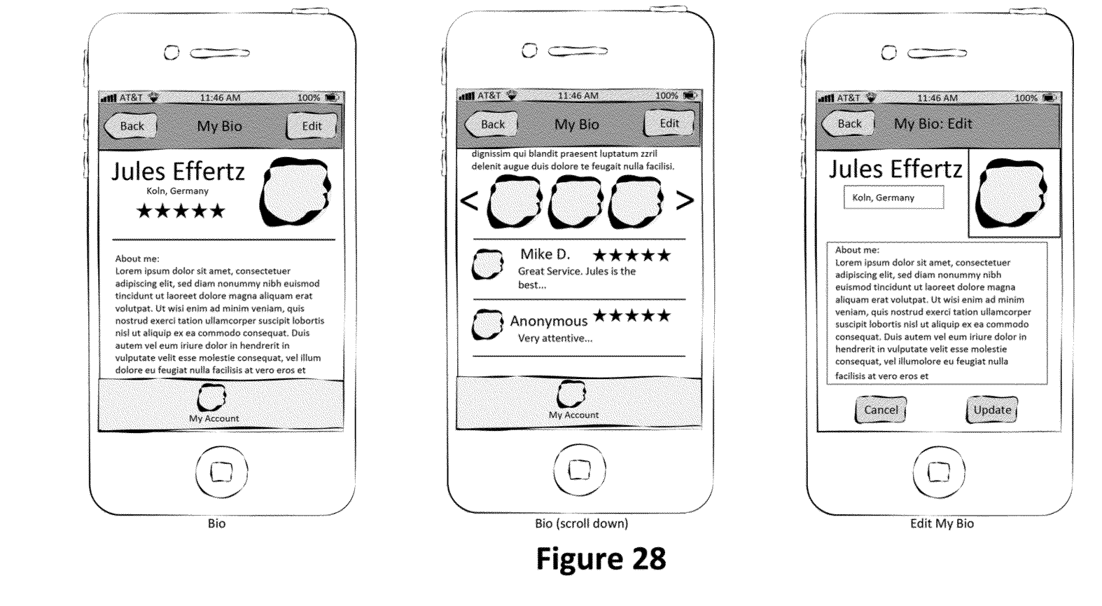

FIG. 28 illustrates various displays of a staff's profile (e.g., waiter) where the waiter may view her own bio, review pictures and access customer's reviews and rating. Also, the display enables a waiter to edit his bio and upload/delete/edit pictures.

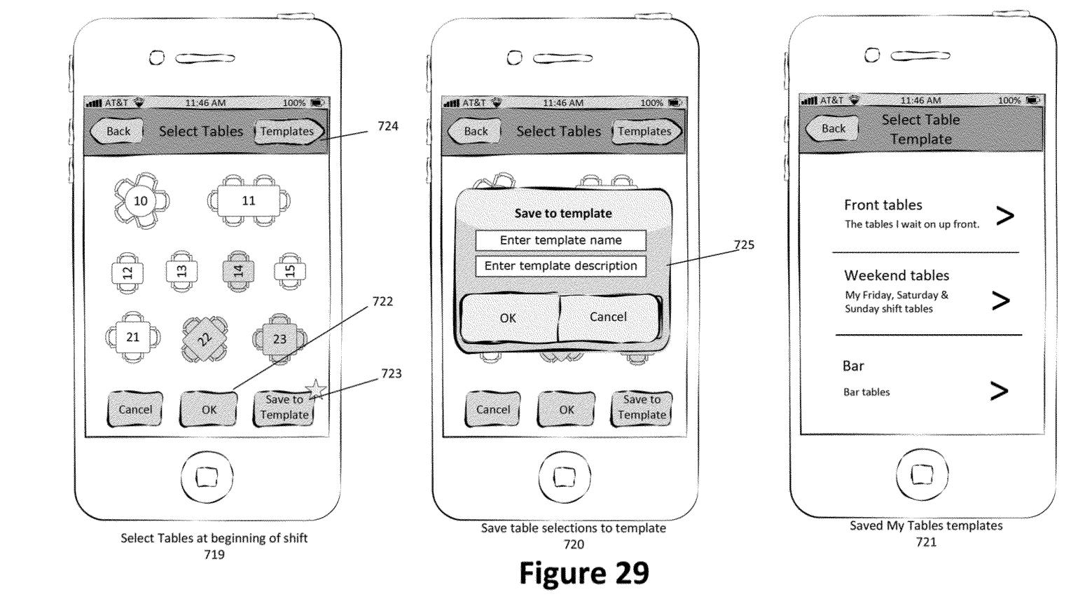

FIG. 29 depicts the process of table management after a waiter clocks in from “My Restaurants” display in FIG. 27. Waiter may select which tables he will be covering using Display 719. Waiter may click on component 722 to be immediately paired to the respective tables, or may select component 724 to access saved templates (a table container) which will lead to Display 721. Waiter may also save the table selection to a template by clicking on component 723 of display 719. Consequently, display 720 is shown with component 725 to save the template name.

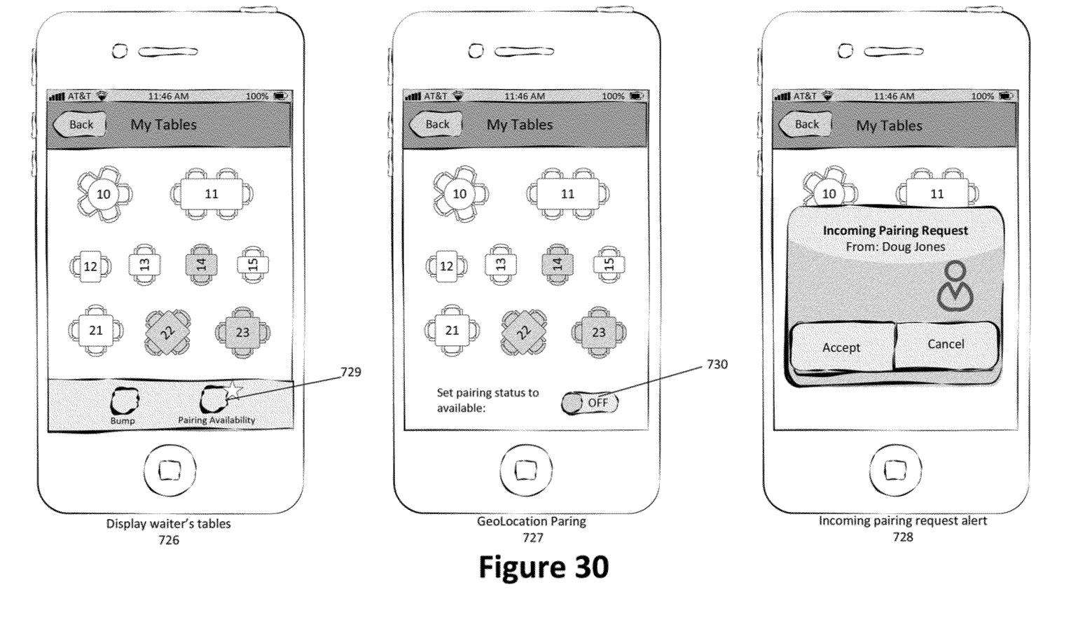

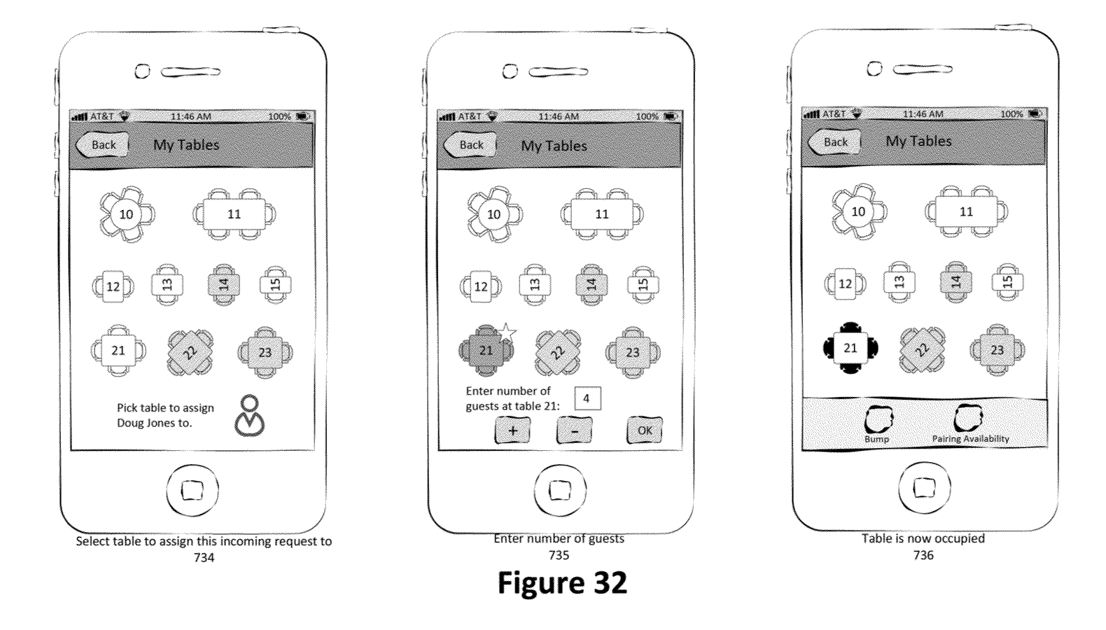

FIG. 30 displays GeoLocation pairing method where Display 726 shows the current tables that the waiter is covering. Prior to customer pairing with the waiter, the waiter clicks on “Pairing Availability” component 729 in Display 726 and is presented with display 727. The waiter may then set Component 730 on to allow incoming GeoLocation pairing requests from customers sitting on their table. Incoming pairing request alert is prompted in Display 728 where the waiter accepts the pairing request. The waiter would then select to which table to assign the new customer using component 734 in FIG. 32.

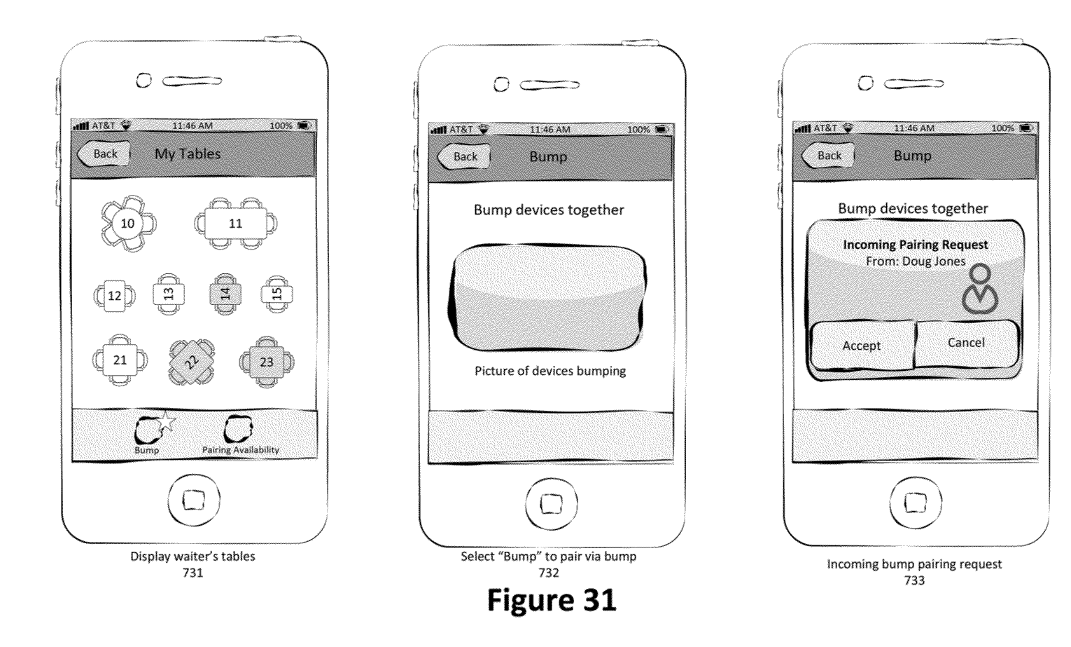

FIG. 31 presents an embodiment where the waiter and customer can initiate a bump based pairing. Display 732 is an illustration of a Bump action displaying how to bump devices together. Incoming pairing request is received upon bumping.

FIG. 32 is a follow up of FIGS. 30 and 31 and corresponds to GeoLocation and Bump pairing methods. Upon pairing, the waiter may assign the customers to a table in Display 734, and is then presented with Display 735 which allows the waiter to input the number of guests. Subsequently, Display 736 is presented with an updated table occupancy notation.

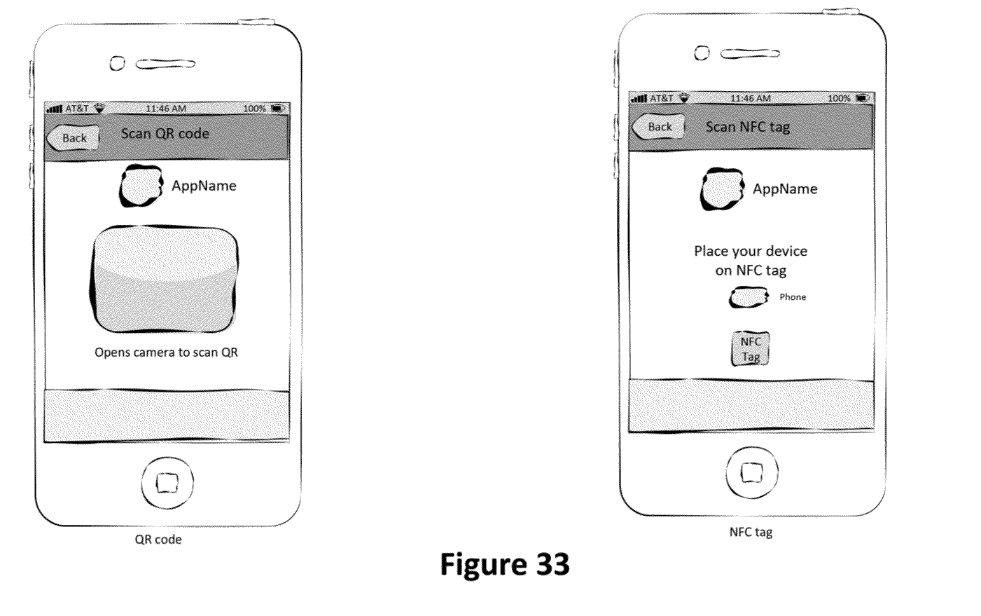

FIG. 33 represents another method to dynamically associate tables with waiters using the waiter-association key based on NFC or QR Code scanning. Automatically scanned tables are added to the My Tables shown in FIG. 29.

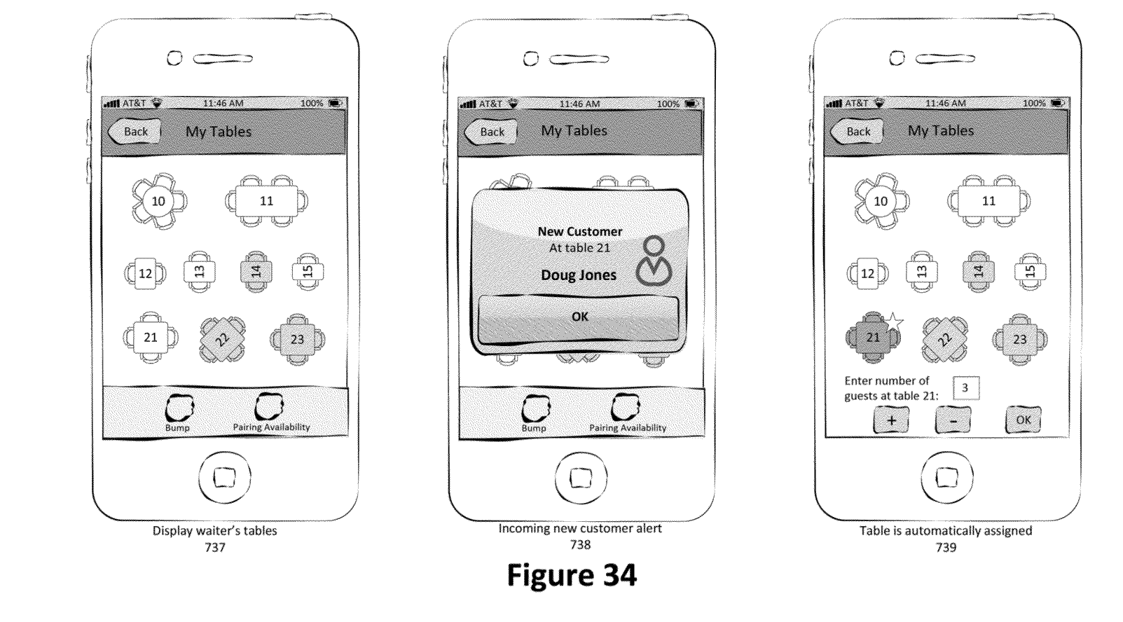

FIG. 34 illustrates the process of pairing using QR or NFC methods. Display 737 presents the current tables that the waiter is covering. Waiter receives an alert when a customer scans their table's QR or NFC code in Display 738. The waiter is then moved to Display 739 requesting number of guests.

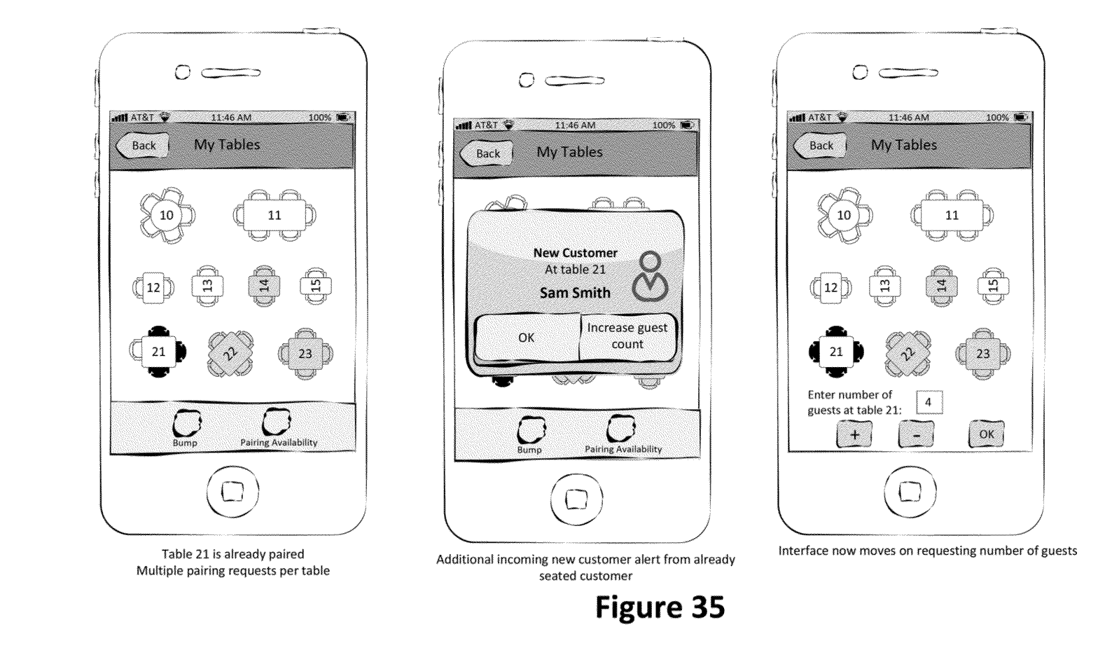

FIG. 35 illustrates multiple customer pairing requests from the same table whenever a table is already paired with customer-waiter association. When a table is paired with a customer's device and additional pairing requests from other devices on the same table are presented to the waiter's device, the waiter may accept the additional pairing request, and may increase the number of guests manually or upon pairing the system will increment the total number of guests on the respective table

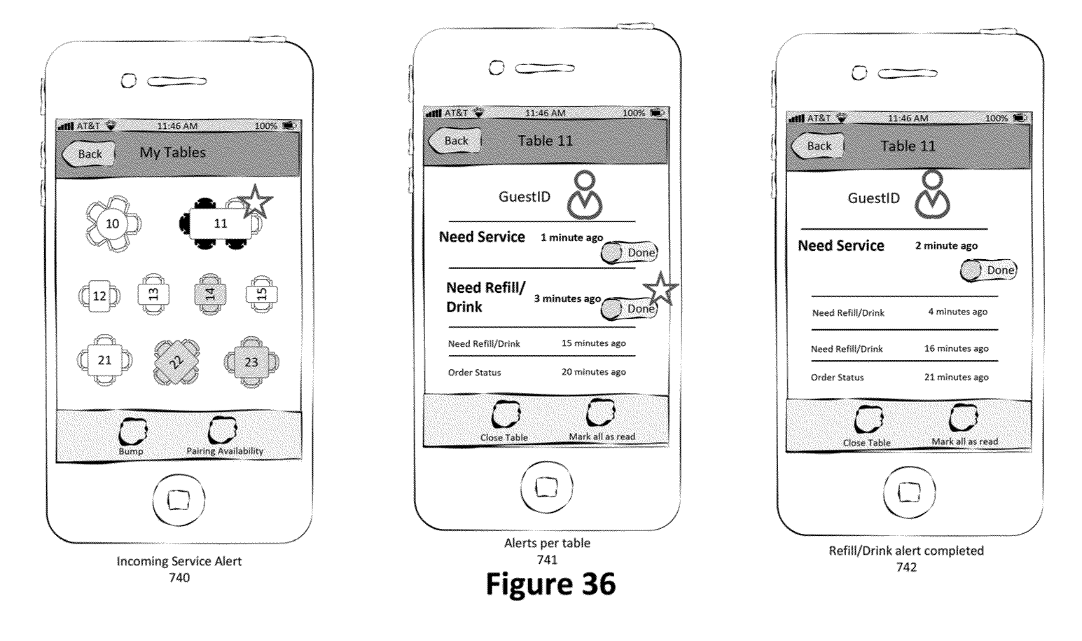

FIG. 36 is an illustration of an active service alert. Upon a receipt of service alert, the waiter may take the appropriate action to complete the request. For example, Display 741 illustrates a “Need Drink/Refill” pending request and Display 742 shows a fulfilled request.

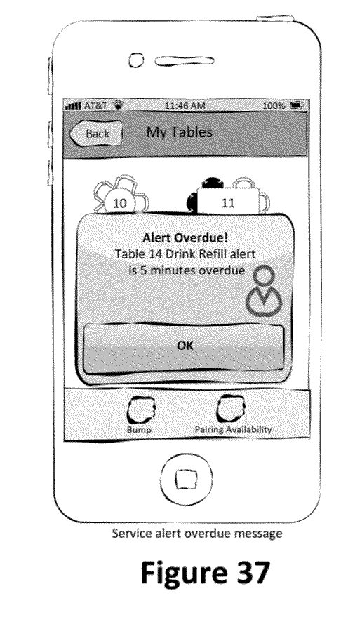

FIG. 37 depicts a service alert overdue message. When a service alert is pending for longer than a certain set time (may be determined by the manager), a screen alert message is displayed.

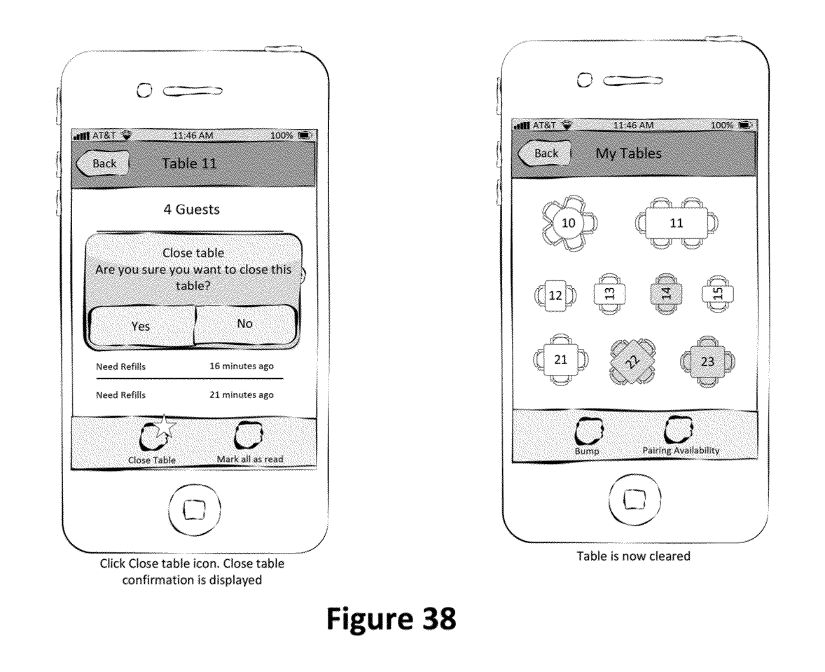

FIG. 38 depicts a process of closing a table upon a customer checking out from a table.

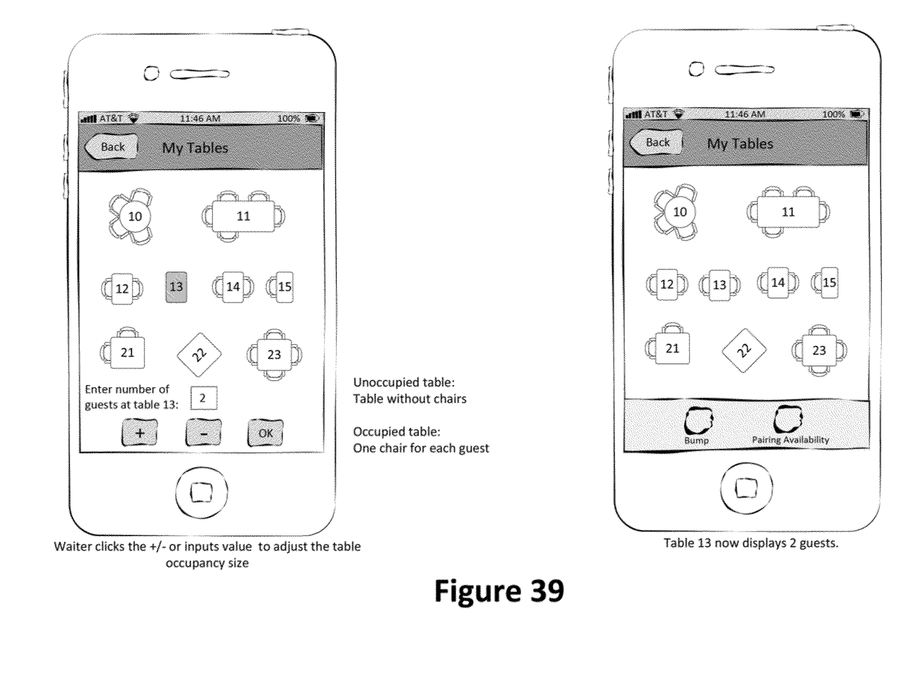

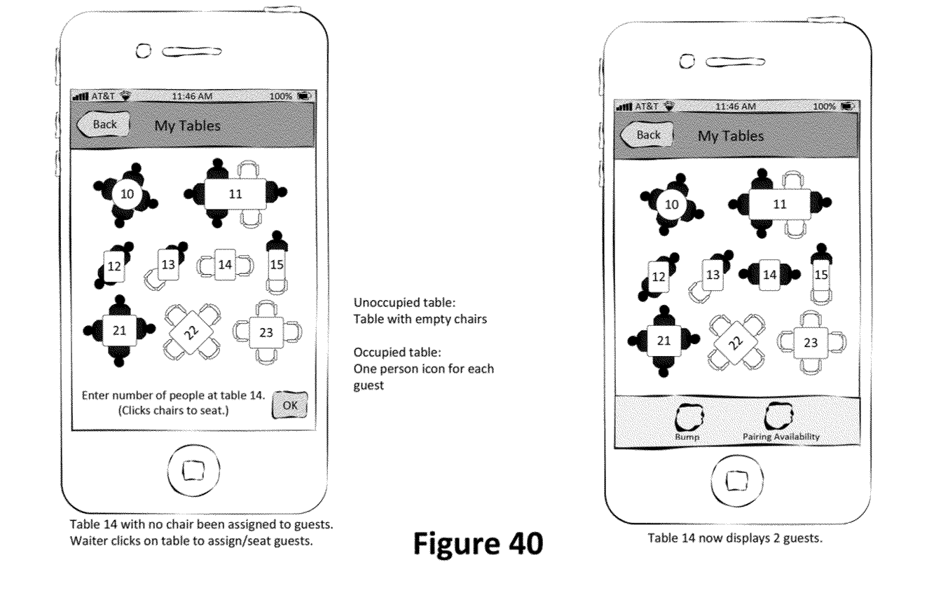

FIGS. 39 and 40 show some other embodiments of different table occupancy labeling conventions. Table maximum and actual occupancy may show tables of other waiters inactive which may be indicated by greyed out (faded), or may be absent from the view. “My Tables” may have an active notation (e.g., red color) which can be unoccupied tables with some distinct notation from occupied tables.

Notations of table occupancy may be any of the following, among several other options: 1) A table with empty chairs indicates zero guests at that point of time, whereas for each guest there will be a chair icon as illustrated in FIG. 39. 2) A table with a display of all chairs at maximum capacity. Seating occupancy is differentiated based on colors as illustrated in FIG. 32. 3) A table with chairs indicates zero guests (i.e., table with 6 empty chairs indicates a max capacity of 6); for each occupied seat, there would be a body/face/head icon tin the chair, as illustrated in FIG. 40.

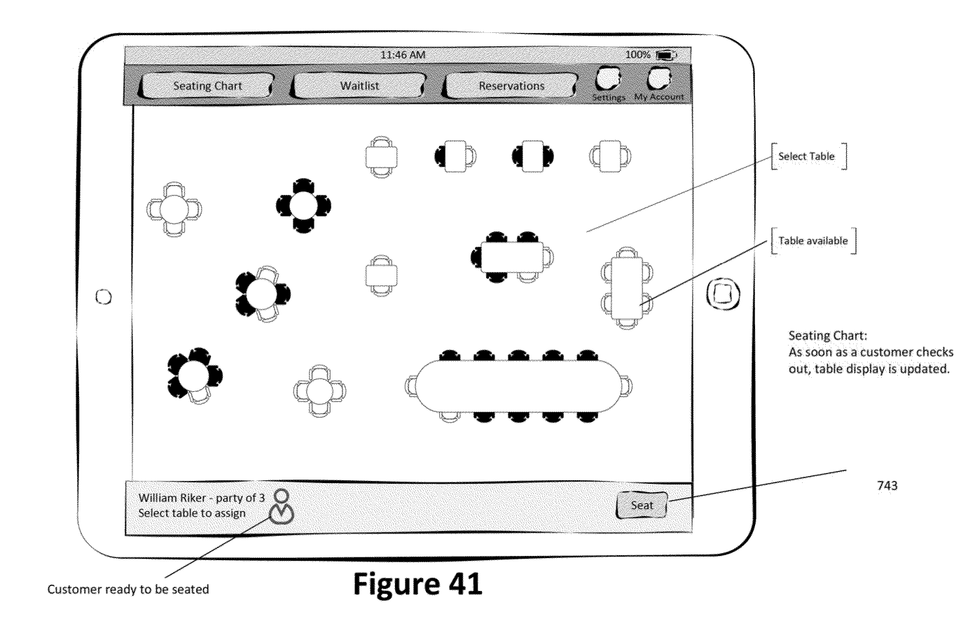

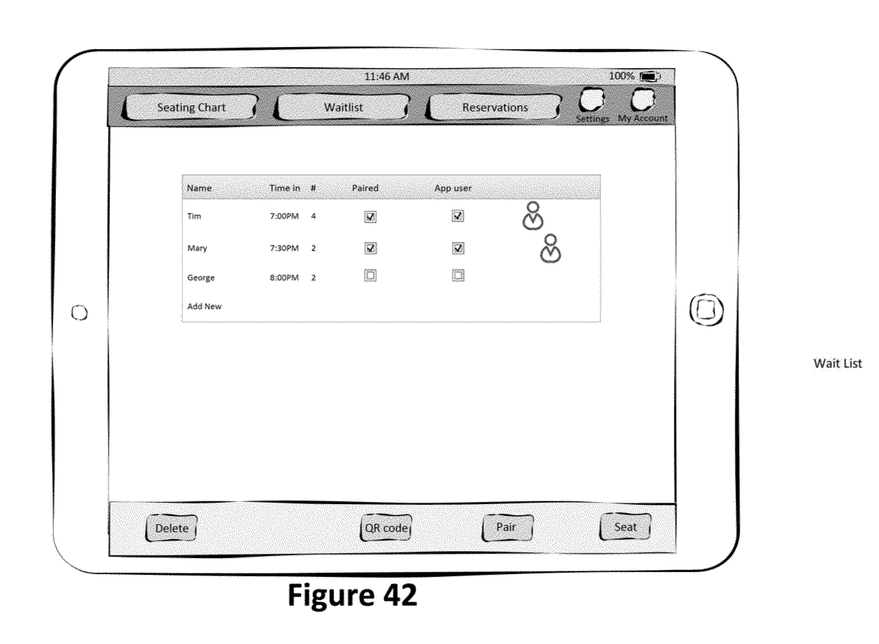

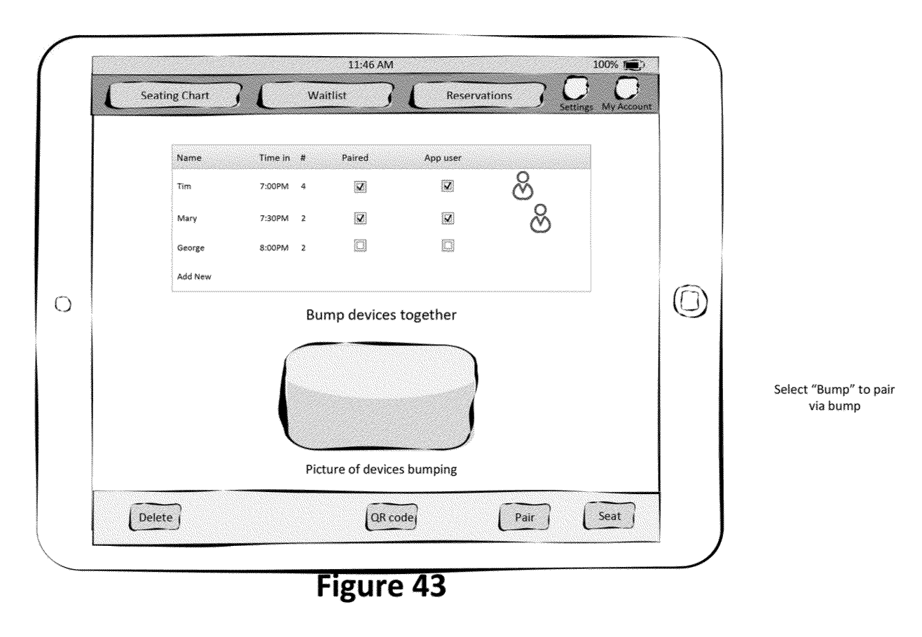

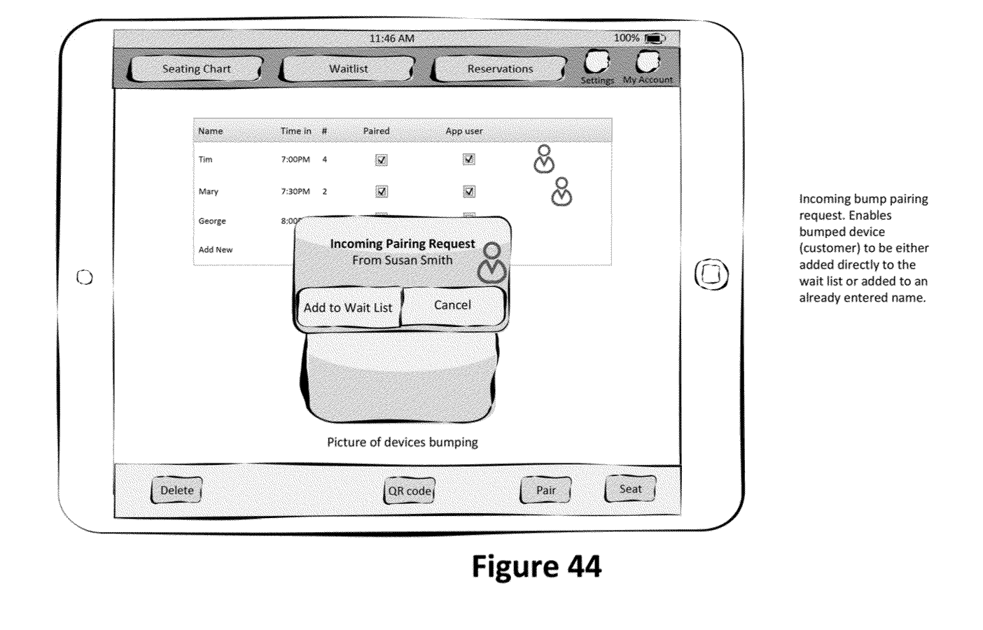

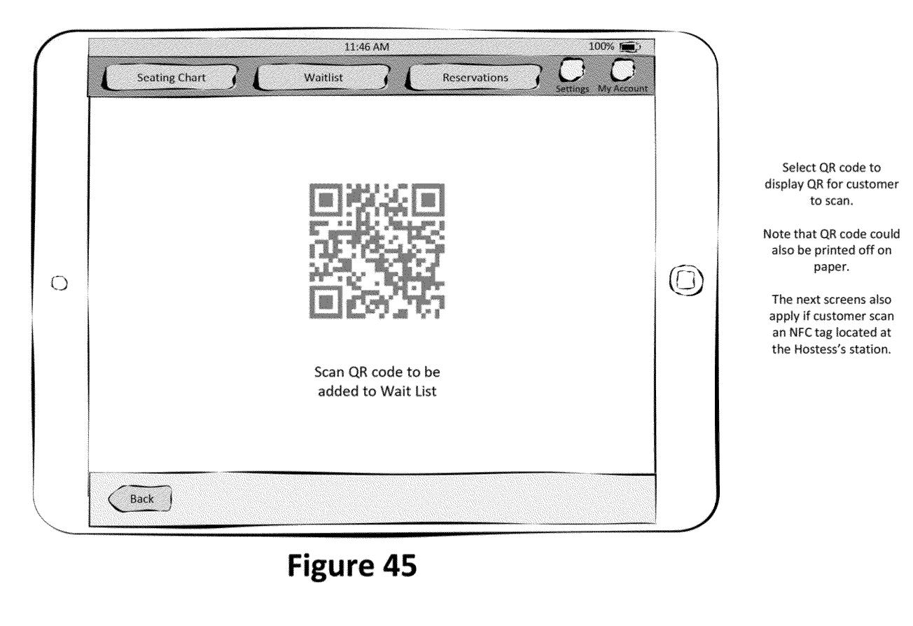

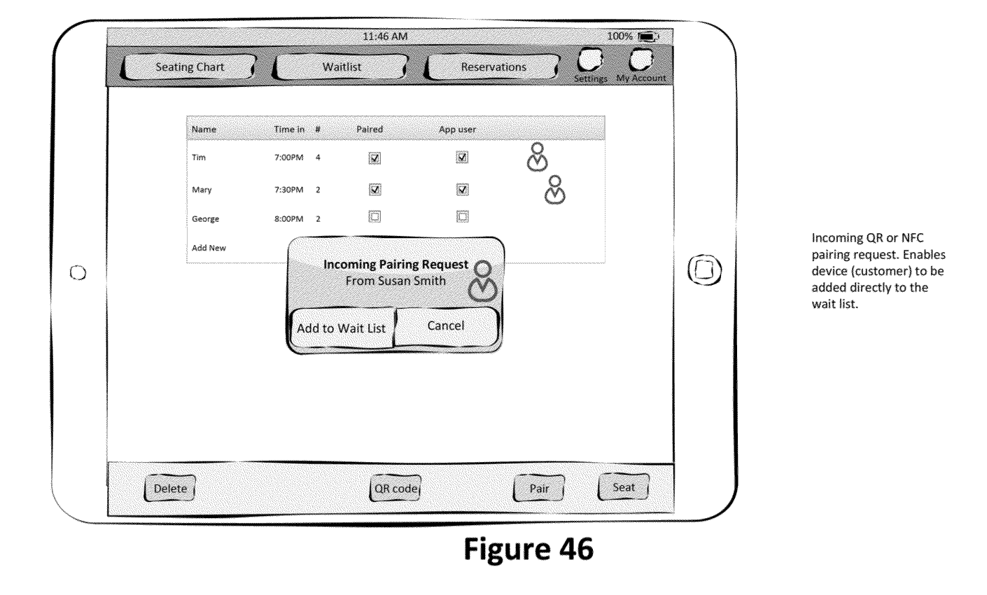

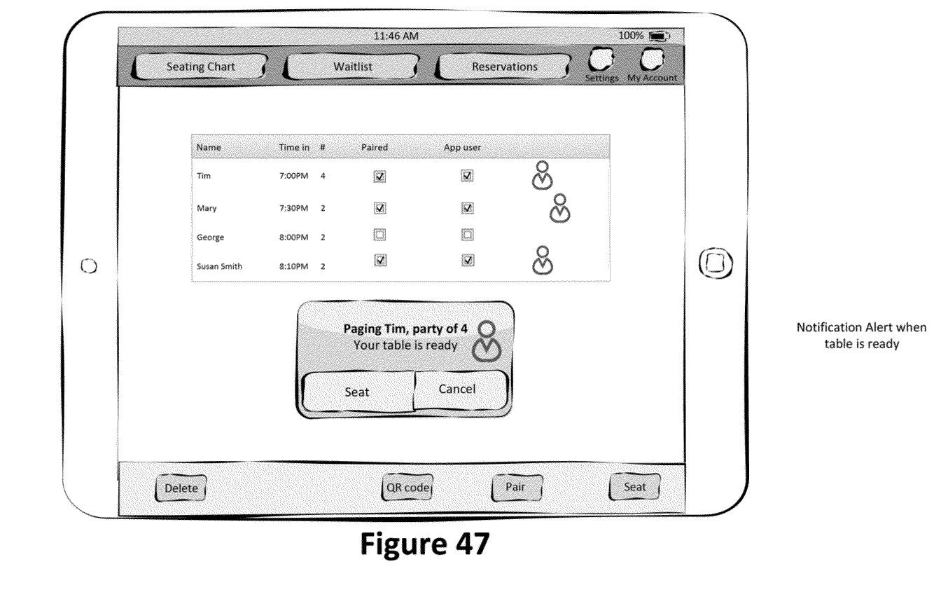

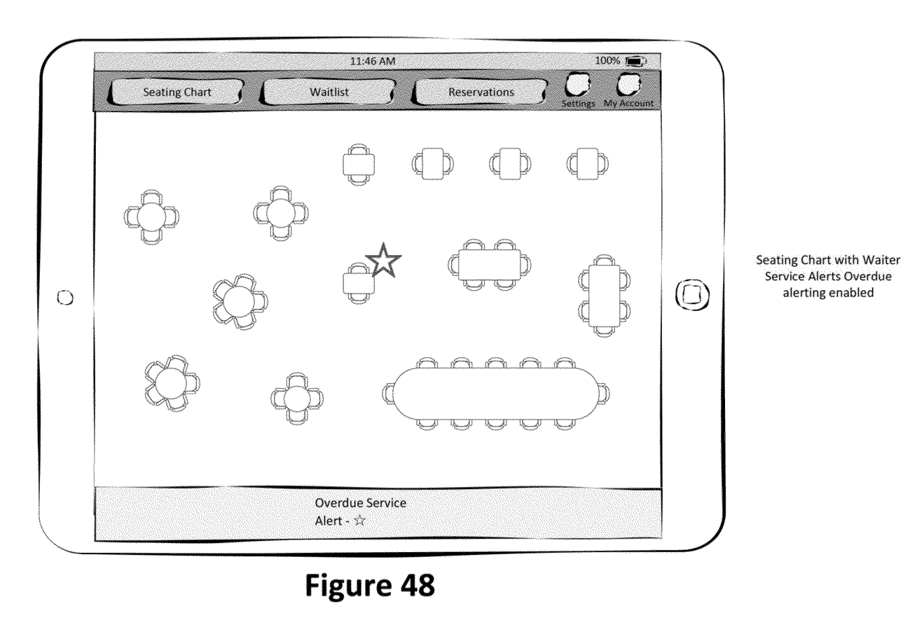

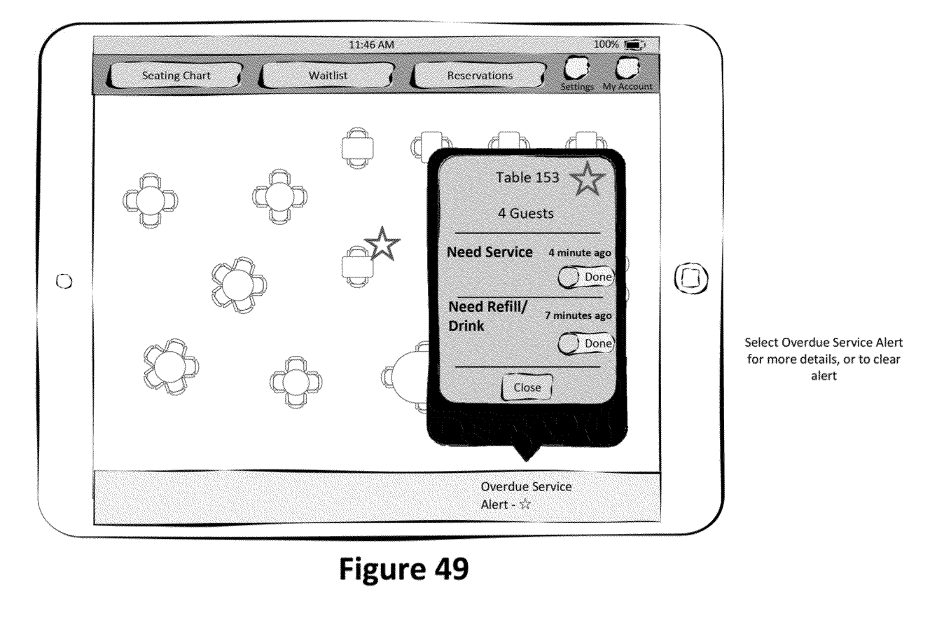

FIGS. 41-50 illustrate the hostess displays. FIG. 41 illustrates the seating chart, component of the system. The hostess can view the occupied and unoccupied tables in the restaurant, receive incoming request for seating assignment, and clicks on Seat component 743 to seat a customer. The hostess would then select the table to seat the customer at FIG. 42 shows the current “Wait List” display with indication of system and paired users. FIG. 43 illustrates the hostess selects to initiate a bump based pairing with the customer's device. An incoming bump pairing request is displayed in FIG. 44. The hostess clicks add to Wait List to directly add the bumped device (customer) to the wait list or seating chart with an indication of number of guests. FIG. 45 illustrates a hostess selecting QR code to display QR for customer to scan or the customer scans an NFC tag located at the hostess's station. FIG. 46 illustrates an incoming QR or NFC pairing request which may be added to a Wait List or to seating chart. FIG. 47 depicts an embodiment of once a table is cleared, an alert pops up that the next customer's table is ready to be seated based on number of guests. FIGS. 48 and 49 depict the seating chart with service alerts overdue enabled. When an alert passes a certain preset threshold, a notation, such as a star, is displayed on the table or bar. The hostess may then detail into the alert or may clear the alert all together.

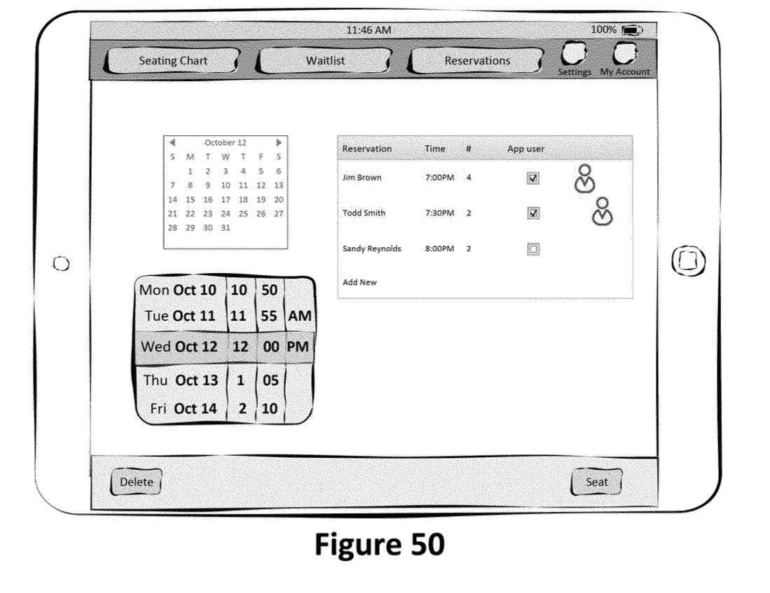

FIG. 50 depicts a reservation where a hostess may view, add, modify, delete, or seat reservations.

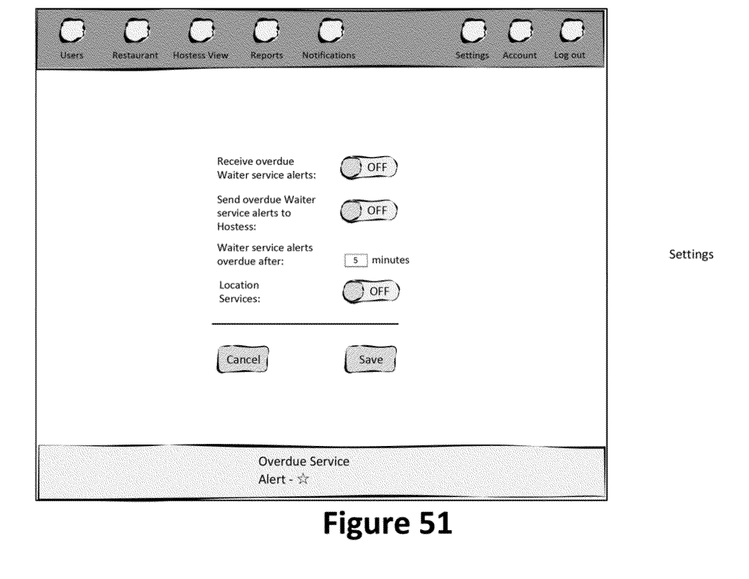

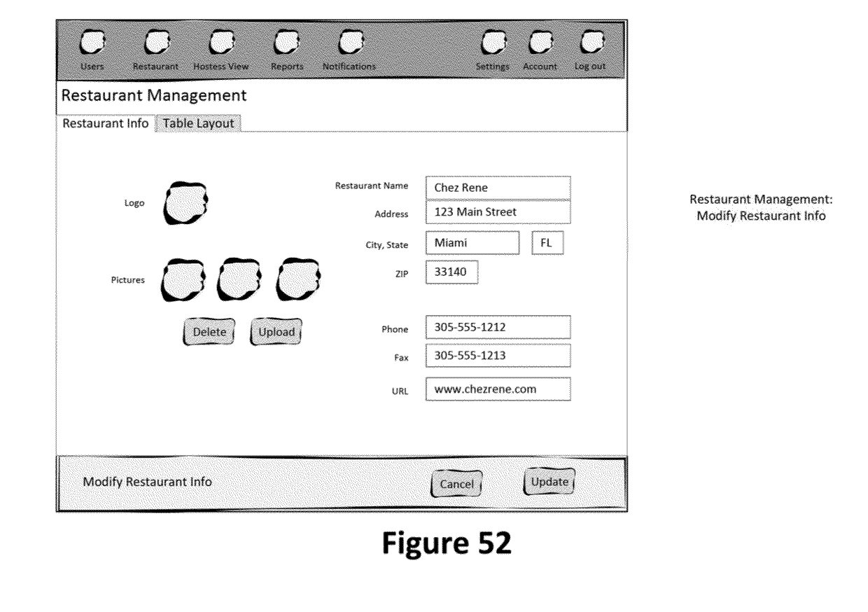

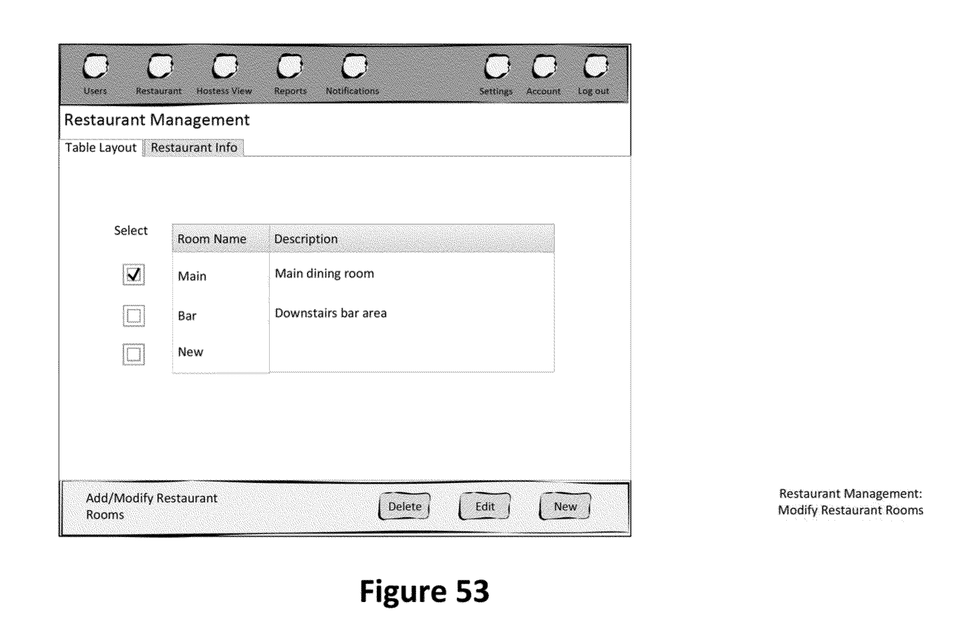

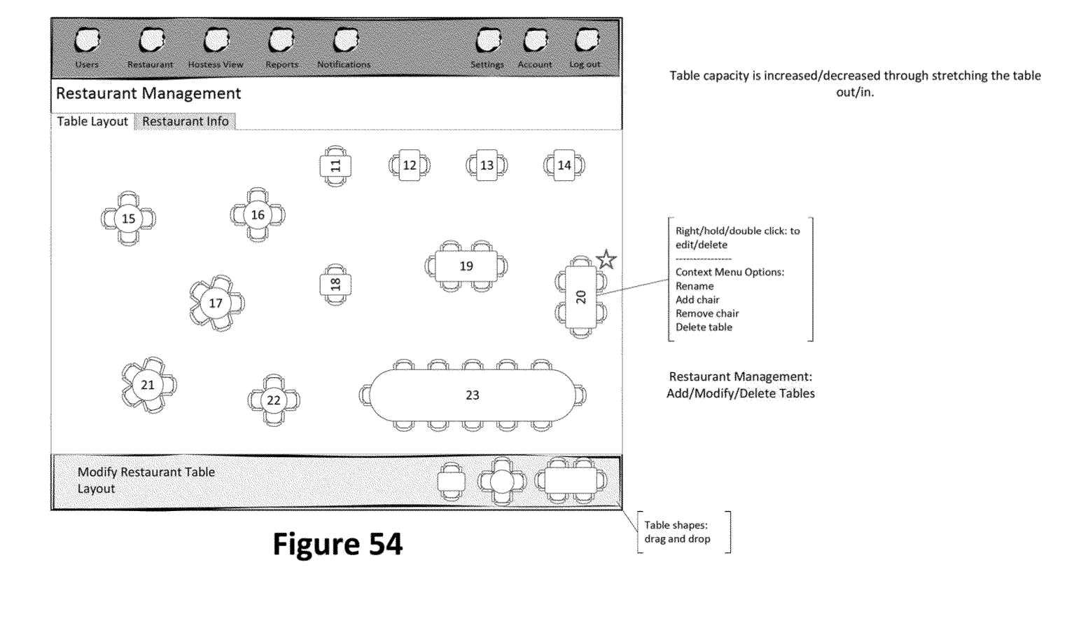

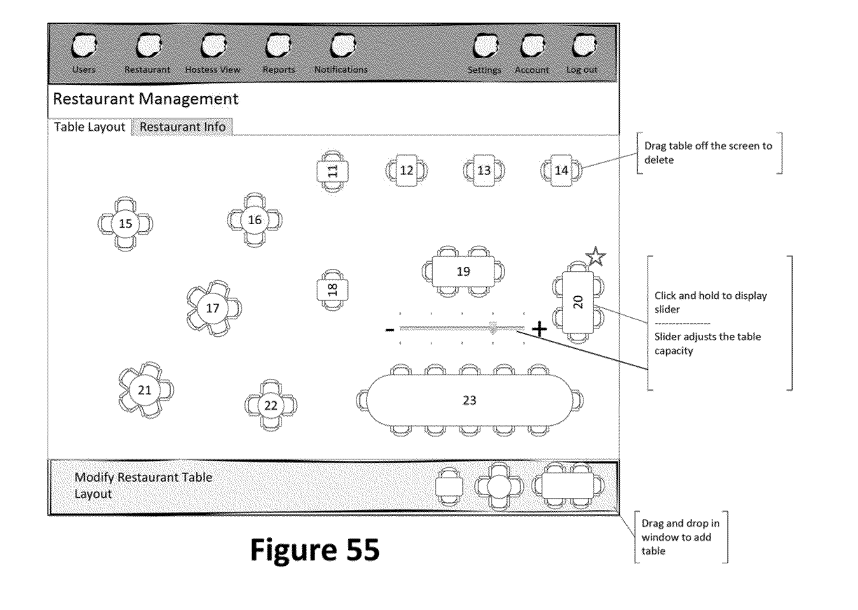

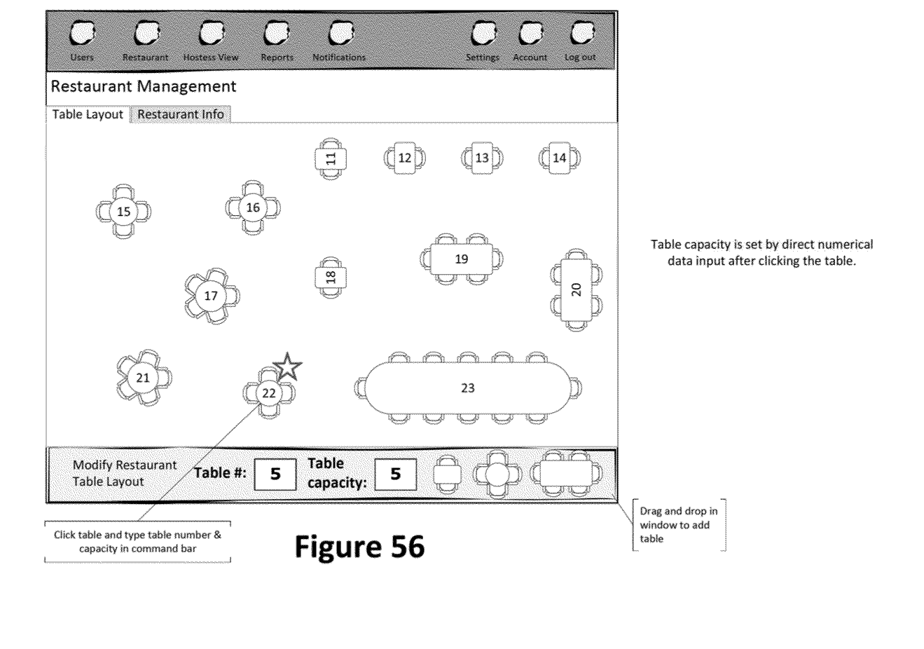

FIGS. 51-60 illustrate the manager displays. FIG. 51 denotes an example embodiment of notification settings. FIG. 52 depicts a restaurant information page where a manager may modify information and upload pictures, among others. FIG. 53 displays table layout area where a manager may add/modify table room names. FIG. 54 illustrates tables editing where after selecting a room, a manager may add, modify or delete tables in that room. Table capacity can also be adjusted by stretching or shrinking, using a scrolling bar as shown in FIG. 55, or using input values as shown in FIG. 56.

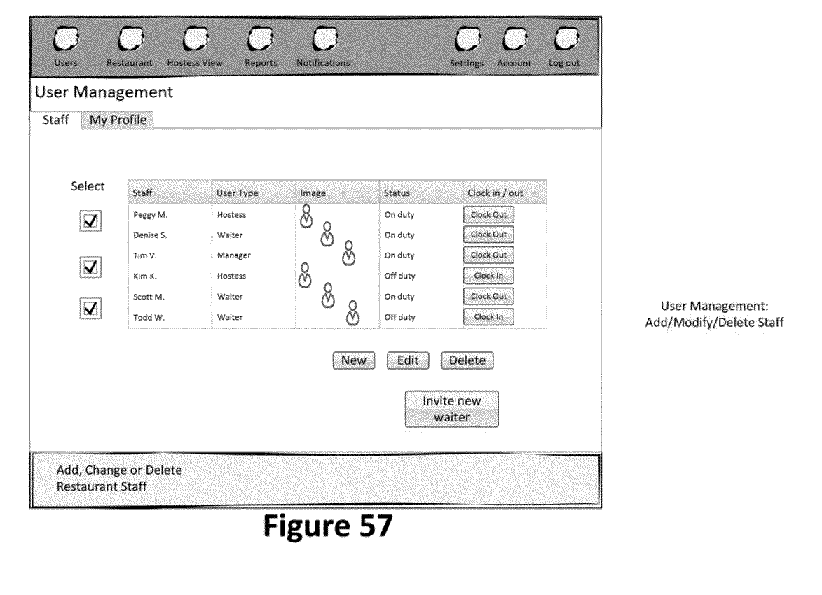

FIG. 57 denotes a display where a manager may add/delete/modify waters, hostesses and other staff. The manager also has the capability to see who is currently off/on duty and clock staff in/out.

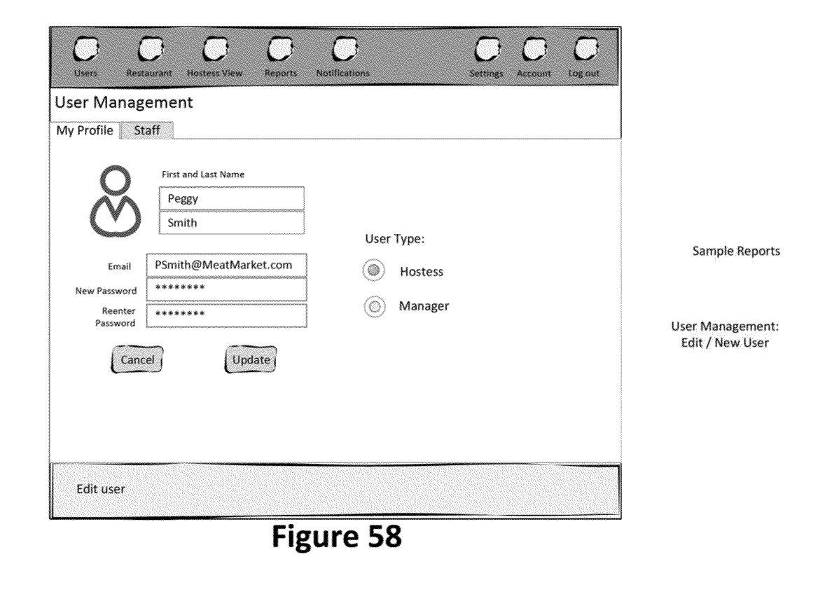

FIG. 58 depicts a display where a manager may create new users, enter or modify user's details.

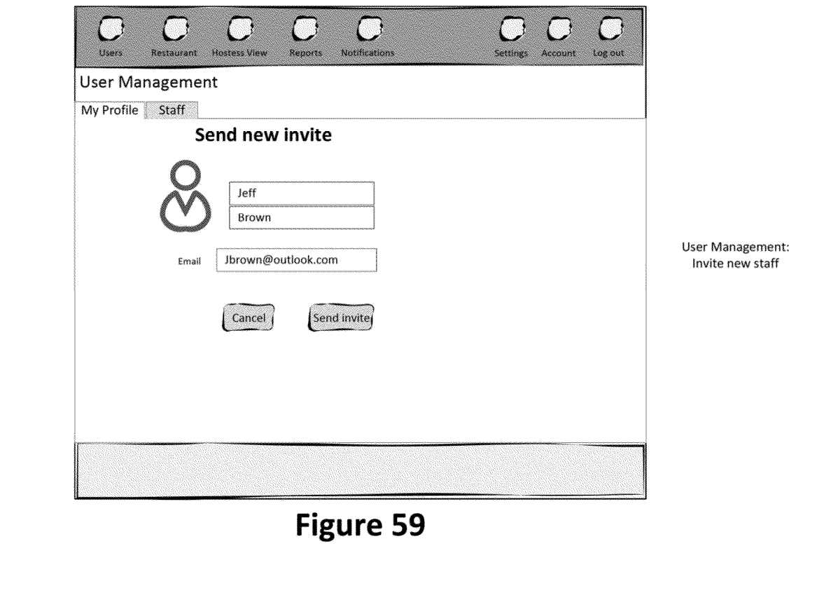

FIG. 59 illustrates a display where a manager gray send an invitation to a staff or a waiter to join their restaurant (after they are hired).

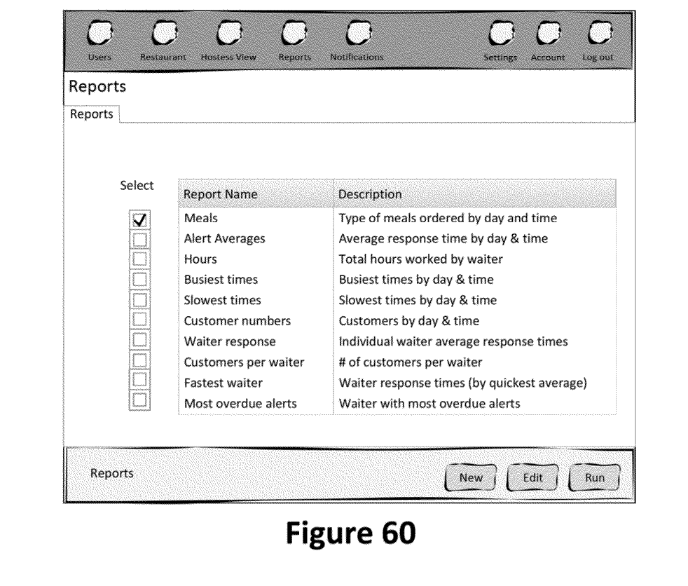

FIG. 60 depicts a display where a manager may run some reports and conduct analytics to assess the efficiency of wait servers (e.g., working hours, table turn around, responsiveness), review server rating, and recruit staff from a single data source of hospitality Staff.

In addition, the manager may pull up the hostess's view where they may assign seating, view wait list, receive table alerts, make reservations, and display overdue service alerts.

The invention claimed:

1. A GPS-based notification system where customers can check in for reservation, are added to a wait list, leave the location, and receive frequent notifications and updates of seating status and time remaining wirelessly when seating is near ready calculated based on the differential distance of customer from the restaurant.

2. The method of claim 1, wherein seating areas in the dining place are occupied and customers are placed on a waiting list for seating. The method where customers receive notifications using wireless data transmission includes, 1) customer identification using unique ID or biometric data; 2) device detection; 3) devices pairing for wireless transmission and communications; 4) seating status updates; among other pertinent customer and restaurant information.

3. The method of claim 1 wherein the system sends notification messages wirelessly to adjacent registered devices.

4. The method of claim 1, wherein the server sends custom notification messages to distant registered devices from the dining place about seating availability or near availability based on a calculated time of distance of customer from the dining area on the basis of GPS coordinates.

5. A communications system for detecting and pairing the wirelessly transmitting and wirelessly receiving devices via Bump, QR code, Geo Location, Near Field Communications, among other choices of device detection and pairing techniques.

6. The method of claim 5, wherein a mobile device sends a short-range signal to a nearby computing device, the signal identifying the adjacent device, via cellular data network, peer-to-peer radio transmission, RFID, Bluetooth and/or wide local area network (WLAN).

7. The device of claim 5, wherein the input sensors are camera, speaker phone sensors, radio signal receiver, heat sensor, optical signal sensor, audio signal sensor, picture motion sensor, and/or radiant heat sensor.

8. The method of claim 5, wherein a customer mobile device and a staff computing device pairing can occur remotely; at the hostess area for table ready alerts; or between wait staff and customers at the table while drinking/eating/dining.

9. A communication system that enables staff (e.g., waiters) to be alerted to customer's service request messages comprising:
Table identification;
Customer(s) identification;
Staff member (e.g. waiter identification) or group of staff identification (e.g., if more than one staff member is serving a table);
Request/alert type;
Request content;
Alert status;
Timestamp receipt;
Timestamp viewed;
Timestamp fulfilled/closed;
Other variables;

10. The method of claim 9, wherein messages are exchanged wirelessly between several information devices (e.g., waiters, hostesses, managers, customers) about customer needs/wants/requests (e.g. need service) based on association factors, such as customer-table-waiter association key, and where many customers may be associated with many waiters within a table using any form of association factors.

11. The method of claim 9, comprising: 1) receiving on a first device requests (notification or alert) to receive data from a second device proximate to the first device and in communication with the first device; 2) detecting receipt of data from the second device; 3) presenting an object (e.g., alert message) on an interface of the first device, the object representing the data received on the first device; and 3) capturing and logging the messages on a server(s).

12. The method of claim 9, wherein as soon as customer(s) is seated, and as soon as the customer is paired with a table, the staff associated with the seating assignment (e.g., table) is automatically notified of the customer(s), and a message of attendance/welcoming is displayed on the client device interface.

13. The method of claim 9, wherein paired devices may communicate with each other synchronously in real-time; or in time-shifted mode where messages are progressively stored on the server as they are received, and later reviewed by the recipient(s).

14. The method of claim 9, wherein a customer mobile device registers with a proximity server. The proximity server can then reply by giving that device a list of connected staff devices at that location to establish synchrony; or staff devices can establish synchrony with registered client devices based on location and customer information.

15. A Method that includes the steps of coupling together a plurality of communication devices where clustered messages on a given request are broadcast as a single object using a “controller” that associates staff members (plurality) so all recipients associated with that table are notified. The controller makes association using Group ID or special key of linked waiters or staff a time of interaction, and any combination of Table ID and Customer IDs.

16. A method for near field communication using input sensors of portable devices which include: 1) thermal/non-thermal sensor that detects an amount related to heat received or released by the heat sensing part from or to an object measured based on the quantity of energy detected by the heat sensing part; 2) the light intensity of a smartphone camera where light that enters through the camera lens, and once translated it into an electronic signal, is measured for intensity and proximity; 3) the speaker of mobile phones serving as an input signal detector where u/sounds of certain frequencies are captured by a remote device and time difference between the pulse transmitted and the echo received is used to determine the devices distance from each other, and those with the closest distance are authenticated and paired.

17. The method of claim 16, wherein the input sensor of a smartphone device issues an activation signal when the detected materials have a magnitude greater than a preset threshold. A detection notification component in the mobile device then receives the activation signal and initiates communication with an additional device that detects a corresponding signal of the device and is configured for communication with the mobile device.

18. A method to review and rate restaurant staff (e.g., waiter, waitress, server, and hostess) based on rating eligibility verification accomplished using customer-staff association key. The review may include a summary analysis of how the server works; what are their strengths and weaknesses; how they deal with errors and conflict; how quick they work, how attendant they are, etc.

19. The method of claim 18, wherein an “impact factor” formula, a measure reflecting the overall effect of the rater's feedback, is computed to assess the rating impact on the overall rating history of the staff being rated.

20. The method of claim 18, where two or multi-party interactions are captured and logged on database servers for later reference and analytics to assess the efficiency of wait servers (e.g., working hours, table turn around, responsiveness), review server rating, and recruit staff from a single data source of hospitality Staff.
